(19) United States
(12) Patent Application Publication
(10) Pub. No.: US 2006/0136318 A1
(43) Pub. Date: Jun. 22, 2006

(54) Automated system for routing orders for financial instruments

(75) Inventors: Kamran L. Rafieyan, Basking Ridge, NJ (US); Peter J. Wright, Gladstone, NJ (US)

Correspondence Address: DAVIDSON, DAVIDSON & KAPPEL, LLC, 485 SEVENTH AVENUE, 14TH FLOOR, NEW YORK, NY, 10018, US

(73) Assignee: Lava Trading Inc., New York, NY (US)

(21) Appl. No.: 10/762,123

(22) Filed: Jan. 21, 2004

(51) Int. Cl. G06Q 40/00

(52) U.S. Cl. 705/37

(57) ABSTRACT

A method for routing orders for financial instruments among users is provided. A first order for one of a plurality of financial instruments is received from a first user, wherein the first order, which includes undisclosed liquidity, includes a first symbol component identifying the one of the plurality of financial instruments, a first side component identifying the order as one of a buy order or a sell order, a first price per unit component, and a first unit quantity. An intention to trade message is sent to each of a plurality of users and the intention to trade message includes information indicative of the first side, first symbol, first price per unit component, and first unit quantity. Information is received regarding one or more orders containing undisclosed liquidity which have been sent to a trade execution entity by one or more of the plurality of users. Based on said information, a responsive order is sent to the trade execution entity to hit or take the undisclosed liquidity.

### RELATED APPLICATIONS

This application is related to U.S. Ser. No. 10/441,750, filed May 20, 2003, entitled “Automated System for Routing Orders for Financial Instruments among Permissioned Users”; and U.S. Ser. No. 10/348,540, filed Jan. 21, 2003, “Automated System for Routing Orders for Financial Instruments Based upon Undisclosed Liquidity”, the entire disclosures of which are hereby incorporated by reference.

### BACKGROUND INFORMATION

There are currently a number of computer accessible trading systems for financial instruments such as stocks, bonds, commodities, derivatives, FX and other securities. One is the conventional stock exchange system exemplified by the New York Stock Exchange and New York Mercantile Exchange. On such exchanges the market is made for each security by a single registered stock dealer, such as a registered stock specialist, who has a seat on the exchange. In addition to face-to-face and telephone communication to the dealers/specialists on the floor, computers are used to send orders to the dealers/specialists on the exchange floor. Information as to the buy and sell prices (bid/offer prices, respectively) are supplied by the dealer/specialist to the exchange and brokers through the dealer/specialist's trading computer terminal. Electronic orders are matched by the dealer/specialist maintaining an orderly market. Upon matching an order the dealer/specialist confirms the execution with the trading terminal and a central computer which stores transaction data.

Another type of system is electronic exchanges which utilize electronic access of dealer posted market prices without a negotiating specialist or floor based exchange. The largest of these is NASDAQ. It is a totally computer-based market where each member dealer can make its own market in the stocks traded on the exchange through a computer network. Dealers trading a significant number of shares in a stock in their own name and profiting from the spread (i.e., the difference between the price which they purchase shares and the price for which they sell them), or from commissions generated from clients, are called market makers. Market makers are most often, but not always, large financial institutions. There are usually a number of market makers in a stock, each bidding and offering stock for themselves or their customers.

The best bid to buy by any market maker and the best offer to sell by any market maker for a security is called the security's “inside market.” NASDAQ supplies trading data to the participants via a computer network at three different service levels, known as Level I, Level II and Level III. Level I, inter alia, allows real-time access to the following data: (1) Inside market quotes (highest bid and lowest offer) for listed securities, (2) individual market maker quotations, as well as inside quotes for OTC Bulletin Board listed securities, (3) trade price and volume data. Level II additionally provides, among other things, real-time price quotations for each Market Maker and prices from other participating non-Market Makers such as ECNs and ATS's. There are various systems for displaying such data, such as disclosed in U.S. Pat. No. 5,297,032 to Trojan et al., issued Mar. 22, 1994.

Electronic exchanges may place, match, record and confirm transactions through their computer network. If a market order is placed through, for example NASDAQ without any restrictions, the NASDAQ computers make the actual match between the order and either the offer price or the bid price and thus will select the parties for the transaction. However a broker may indicate a preference to buy from or sell to a particular market maker.

Historically, market makers have solely determined the prices for securities on electronic exchanges such as NASDAQ. Non-members must place their orders and their customers' orders with a member dealer who receives a placement fee. Similar to other securities exchanges, electronic exchanges, such as NASDAQ, receive a fee for each such transaction.

NASDAQ also operates two automated execution systems, the SuperMontage® System (also known as the SOES® System) and SelectNet®. SuperMontage is a system that provides automatic execution of market and marketable limit orders, while SelectNet offers delivery of orders with the ability to negotiate or execute those orders. SelectNet is also used to send liability orders to electronic communications networks (ECNs) and unlisted trading privileges (UTP) exchanges that do not participate in autoexecution in SuperMontage.

SuperMontage is an automated trading system that lets SuperMontage participants enter and execute orders in active SuperMontage authorized NASDAQ securities. Reports of executions are sent to the Automated Confirmation Transaction Services^{SM} (ACT) to be reported to the tape, and then both sides of the transaction are sent to the applicable clearing corporation(s) as locked-in trades for clearance and settlement.

SelectNet offers traders the ability to automate the negotiation and execution of trades. The maximum order size in SelectNet is 999,999 shares. Executions are automatically reported to ACT for public dissemination and sent to clearing for comparison and settlement. SelectNet also identifies incoming and outgoing orders and allows the market participant to see subsequent messages and negotiation results. These services are described in more detail in NASDAQ TRADING MANUAL (2001), the entire disclosure of which is hereby incorporated by reference.

A third type trading system is alternative trading systems (“ATS”), such as an ECN, which also provides its members and electronic exchange users, such as NASDAQ users, an electronic network by which they may display and execute their orders independent of a market maker or specialist. Examples of ECNs include Instinet, ARCA, BRUT, BTRD, and Island. Other ATSs include NASDAQ's Primex System and NYFIX's Millennium System.

Members of an ECN typically have a trading terminal that is connected with the ECN's order book computer. Members display their bids and offers and conduct transactions through the resulting network. The ECN's order book computer keeps track of bid/offer information including price, volume, and execution for each open and closed transaction as supplied to it in real time by its members. The order book computer also records which computer, and thus, which member posted each bid or offer. Once a bid is hit or an offer is taken through the central order book computer, the central order book and members' trading terminals are so updated and the accepted bids and offers are no longer displayed.

ECNs were originally developed for their members to trade amongst themselves. Thus, each ECN developed its own terminals and protocols. The ECN receives a fee, normally based on transaction volume, for each transaction.

In a conventional stock exchange or an electronic exchange, buyers and sellers are subjected to intermediaries in the transaction, i.e., respectively the specialist or the market maker dealing in a particular security. However, in an ECN, each bid and offer is a discrete and anonymous order, fully viewable by and accessible to all its members. Accordingly a broker/dealer member or for that matter, simply a member, may have a number of bids and offers at different prices, posted on an ECN's order book. There are no specialist or dealer intermediaries for these orders, thus removing third party delays and fees typically associated with traditional exchanges and electronic exchanges. The member controls through its trading computer all aspects of trading securities including order entry, price, volume, duration and cancellation. The member may, at its discretion, select desirable transactions from all open orders available as displayed from the ECN's order book. The member may choose from the inside market for the security or at a worse price outside of the inside market. Such freedom is highly desirable. For example, it may be a wise strategy to buy securities at a price equal to or higher than the best offer in order to obtain more shares than the inside offer is displaying at any given point in time. This strategy also recognizes that the inside market is moving quickly and may not be available when trying to take the best offer.

U.S. Pat. No. 6,278,982, assigned to Lava Trading, Inc., describes a securities trading consolidation system where each customer uses a single trader terminal to view, and analyze security market information from and to conduct security transactions with two or more ECNs, or other comparable ATSs, alone or in combination with one or more electronic exchanges. A consolidating computer system supplies the market information and processes the transactions. The consolidating computer system aggregates order book information from each participating ECN order book computer including security, order identification, and bid/ask prices information. Bid and ask prices for participating electronic exchanges may be integrated into the display. The combined information is displayed to a customer by security and by bids and offers, and then sorted by price, volume and other available attributes as desired by the customer. The consolidating computer system forwards to each trading terminal information from only those market maker ECNs and electronic exchanges that the customer is an ECN member or electronic exchange user and thus entitled to receive.

Another type of trading system manages broker-to-broker trades, as it is also possible for broker/dealer's to trade directly with each other. For example, many OTC market makers (who are brokers) implement direct trading with other brokers using auto-execution trading engines. In this system, a market maker can automatically execute incoming market orders and marketable limit orders on selected securities up to a maximum number of shares. The selected securities and number of shares can be modified as desired. Some of these auto-execution engines are proprietary or are managed by third party vendors. Such broker to broker trades are often facilitated by networks such as Nasdaq's ACES or Sungard's BNET networks, each of which typically charge a fee per message sent between brokers.

### SUMMARY OF THE INVENTION

In accordance with a first embodiment of the present invention, a method for routing orders for financial instruments among permissioned users is provided. The system includes a plurality of users, wherein each user designates one or more other users as its permissioned users. Each user may selectively generate an intention to trade message and send the intention to trade message to said each user's permissioned users. Then intention to trade message corresponds to a first order of the user for one of a plurality of financial instruments. The first order includes a first symbol component identifying the one of the plurality of financial instruments, a first side component identifying the order as one of a buy order or a sell order, a first price per unit component, and a first unit quantity. The intention to trade message includes information indicative of the first side, first symbol, first price per unit component, and first unit quantity. Each user also receives intention to trade messages from its permissioned users; and, selectively sends a responsive order message to the permissioned user that generated the intention to trade message. Preferably, the order message is a liability order. The responsive order message corresponds to a reciprocal order for the one of the plurality of financial instruments and the order message includes a second symbol component identifying the one of the plurality of financial instruments, a second side component identifying the order as one of a buy order or a sell order, a second price per unit component, and a second unit quantity. Finally, each user, upon receiving a responsive order message in accordance with step (b), selectively sends an execution message confirming trade execution to the user that generated the responsive order message. In this manner, each user may enter into user-to-user direct trades with only its permissioned users. In accordance with this embodiment, there are no limitations on the type of liquidity that can be traded. In other words, the liquidity can be allocated liquidity (i.e., quantities that have also been sent to trade execution entities such as exchanges or ATS's) or unallocated liquidity, and the allocated liquidity can include liquidity that is “visible” to third parties, for example, as market data, as well as liquidity that is not visible to third parties, such as Sweep order quantities, for example.

In accordance with certain embodiments of the present invention, user-to-user direct trades are limited to trading “undisclosed liquidity.” As used herein, an order comprises “undisclosed liquidity” if any of it's original quantity is not currently sent to any exchange, ATS, ECN, or other trade execution entity as a “visible” order. In other words, “undisclosed liquidity” includes i) liquidity that has not been allocated (i.e., sent) to any trade execution entity and ii) liquidity that has been allocated to a trade execution entity, but is not “visible” to third patties as market data. As such, any order, regardless of its order type, comprises “undisclosed liquidity” unless or until it is sent to an exchange, ATS, or other trade execution entity (as contrasted with the permissioned users described below). However, in accordance with some embodiments, certain order types, such as the SWEEP order described below, may retain “undisclosed liquidity” even after the corresponding order is sent to the ATS, ECN, exchange or trade execution entities because SWEEP orders are not reflected in the market data and are therefore never “visible” to other users. In other embodiments, any component of a SWEEP order which has been sent to the trade execution entity ceases to be undisclosed liquidity. In these embodiments, “undisclosed liquidity” is more narrowly defined as an order quantity that has not yet been sent to any exchange, ATS, ECN or other trade execution entity.

In accordance with a first embodiment of the present invention, a system and method for routing orders for financial instruments among permissioned users is provided. Orders for financial instruments are monitored from a first user. Each order includes a first price per unit component, and a first unit quantity, and the orders comprise undisclosed liquidity. The first user has one or more permissioned users, and the system and method monitors reciprocal orders for financial instruments from each of the one or more permissioned users. Each reciprocal order includes a second price per unit component and a second unit quantity, the first and second price per unit components having overlapping values, and the reciprocal orders comprise undisclosed liquidity that has not been sent to any trade execution entity. For each reciprocal order, an execution message is sent to the corresponding permissioned user confirming trade execution if at least a portion of the first quantity has not previously been sent to any trade execution entity or previously executed to any permissioned user. For each execution message, the corresponding trade execution is reported in accordance with governmental trade reporting requirements.

In accordance with a second embodiment of the present invention, a system and method for routing orders for financial instruments among permissioned users is provided. In this regard, the system includes a first user, and the first user has one or more permissioned users. The system and method receives an intention to trade message from one of the permissioned users, wherein the intention to trade message corresponds to a second order on the permissioned user for one of a plurality of financial instruments. The second order includes a second symbol component identifying the one of the plurality of financial instruments, a second side component identifying the order as one of a buy order or a sell order, a second price per unit component, and a second unit quantity, and the intention to trade message includes information indicative of the second side, second symbol, second price per unit component, and second unit quantity. The system and method further receives a first order for the one of a plurality of financial instruments from a first user, wherein the first order includes undisclosed liquidity. The first order includes a first symbol component identifying the one of the plurality of financial instruments, a first side component identifying the order as one of a buy order or a sell order, a first price per unit component, and a first unit quantity. If the second order is a reciprocal order of the first order, an order message is sent to the corresponding permissioned user requesting trade execution if at least a portion of the first quantity has not previously been sent to any trade execution entity or previously executed to any permissioned user. If the second order is not a reciprocal order for the first order, an intention to trade message is sent to each permissioned user, and the intention to trade message includes information indicative of the first side, first symbol, first price per unit component, and first unit quantity.

In accordance with a third embodiment, a system and method for routing orders for financial instruments among permissioned users is provided. In this regard, the system includes a first user, and the first user has one or more permissioned users. Updated order book information is received from each of a plurality of trade execution entities. The updated order book information includes, for each of a plurality of financial instruments, a current bid price with a corresponding disclosed liquidity quantity and a current offer price with a corresponding disclosed liquidity quantity. The system and method receives an intention to trade message from one of the permissioned users. The intention to trade message corresponds to a second order on the permissioned user for one of a plurality of financial instruments, and the second order includes a second symbol component identifying the one of the plurality of financial instruments, a second side component identifying the order as one of a buy order or a sell order, a second price per unit component, and a second unit quantity. The intention to trade message includes information indicative of the second side, second symbol, second price per unit component, and second unit quantity. The system and method receives a first order for the one of a plurality of financial instruments from the first user, wherein the first order includes undisclosed liquidity. The first order includes a first symbol component identifying the one of the plurality of financial instruments, a first side component identifying the order as one of a buy order or a sell order, a first price per unit component, and a first unit quantity. The system and method sends at least a portion of the first order to a first one of the plurality of trade execution entities for execution, and, for any remaining quantity of the first quantity of the first order: (1) if the second order is a reciprocal order of the first order, sends an order message to the corresponding permissioned user; (2) if the second order is not a reciprocal order fo the first order, sends an intention to trade message to each permissioned user, the intention to trade message including information indicative of the first side, first symbol, first price per unit component, and the remaining quantity.

In accordance with other embodiments of the present invention, execution based on intention to trade messages occurs at a trade execution entity such as an ECN or other ATS.

In accordance with one such embodiment of the present invention, a method for routing orders for financial instruments among users is provided. An intention to trade message is transmitted from a first of a plurality of users to at least one and preferably, at least two, other ones of the plurality of users. The intention to trade message corresponds to a first order on the first user for one of a plurality of financial instruments. The first order includes a first symbol component identifying the one of the plurality of financial instruments, a first side component identifying the order as one of a buy order or a sell order, a first price per unit component, and a first unit quantity. The intention to trade message includes information indicative of the first side, first symbol, first price per unit component, and first unit quantity.

At one of said other users, a second order for the one of a plurality of financial instruments is received from said one other user. The second order includes a second symbol component identifying the one of the plurality of financial instruments, a second side component identifying the order as one of a buy order or a sell order, a second price per unit component, and a second unit quantity.

If the second order is a reciprocal order of the first order, the second order, or a portion thereof, is sent to a trade execution entity as an initiating order, and information indicative of the initiating order is sent to the first user. At least a portion of the second unit quantity of the initiating order is an undisclosed quantity and the initiating order has a third price per unit component. Preferably, the third price per unit component is between the first and second price per unit components.

At the first user, based upon said information indicative of the initiating order sent to the first user, a responsive order is sent to the trade execution entity. The responsive order has the first side component, the first symbol component, a unit quantity, and the third price per unit component.

In accordance with another such embodiment of the present invention, a method for routing orders for financial instruments among permissioned users is provided. An intention to trade message is received from a first one of one or more permissioned users of a first user. The intention to trade message corresponds to a second order on the first permissioned user for one of a plurality of financial instruments. The second order includes a second symbol component identifying the one of the plurality of financial instruments, a second side component identifying the order as one of a buy order or a sell order, a second price per unit component, and a second unit quantity. The intention to trade message includes information indicative of the second side, second symbol, second price per unit component, and second unit quantity.

A first order for the one of a plurality of financial instruments is received from the first user. The first order includes undisclosed liquidity, and includes a first symbol component identifying the one of the plurality of financial instruments, a first side component identifying the order as one of a buy order or a sell order, a first price per unit component, and a first unit quantity.

If the second order is a reciprocal order of the first order, the first order, or a portion thereof, is sent to a trade execution entity as an initiating order, and information indicative of the initiating order is sent to the first permissioned user. At least a portion of the second unit quantity of the initiating order is an undisclosed quantity, and the initiating order has a third price per unit component.

If the second order is not a reciprocal order of the first order, an intention to trade message is sent to each permissioned user. The intention to trade message includes information indicative of the first side, first symbol, first price per unit component, and first unit quantity.

In accordance with another such embodiment of the present invention, a method for routing orders for financial instruments among users is provided. A first order for one of a plurality of financial instruments is received from a first user, wherein the first order, which includes undisclosed liquidity, includes a first symbol component identifying the one of the plurality of financial instruments, a first side component identifying the order as one of a buy order or a sell order, a first price per unit component, and a first unit quantity. An intention to trade message is sent to each of a plurality of users and the intention to trade message includes information indicative of the first side, first symbol, first price per unit component, and first unit quantity. Information is received regarding one or more orders containing undisclosed liquidity which have been sent to a trade execution entity by one or more of the plurality of users. Based on said information, a responsive order is sent to the trade execution entity to hit or take the undisclosed liquidity.

In accordance with yet another such embodiment of the present invention, a method for routing orders for financial instruments among users is provided. In this embodiment, a plurality of users is provided, wherein each user designates one or more other users as its permissioned users.

Each user selectively generates an intention to trade message, wherein the intention to trade message corresponds to a first order of the user for one of a plurality of financial instruments. The intention to trade message is sent to said each user's permissioned users. The first order includes a first symbol component identifying the one of the plurality of financial instruments, a first side component identifying the order as one of a buy order or a sell order, a first price per unit component, and a first unit quantity, and the intention to trade message includes information indicative of the first side, first symbol, first price per unit component, and first unit quantity.

Each user receives intention to trade messages from its permissioned users, and selectively sends an initiating order to a trade execution entity. Information indicative of the initiating order is sent to each of the plurality of users. In this regard, the initiating order corresponds to a reciprocal order for the one of the plurality of financial instruments, and the initiating order includes a second symbol component identifying the one of the plurality of financial instruments, a second side component identifying the order as one of a buy order or a sell order, a second price per unit component, and a second unit quantity. The second unit quantity includes an undisclosed liquidity quantity. Each user, upon receiving said information indicative of the initiating order, selectively sends a responsive order to the trade execution entity to hit or take at least a portion of the undisclosed liquidity quantity.

In accordance with other embodiments of the present invention, computer readable media are provided which have stored thereon computer executable process steps operable to control a computer(s) to implement the embodiments described above.

### BRIEF DESCRIPTION OF THE DRAWINGS

FIG. 1 shows an exemplary system that can be used to implement the embodiments of the present invention.

FIG. 2 shows an illustrative graphical user interface for entering orders into the system of FIG. 1.

FIG. 3 shows an embodiment of the present invention for routing orders for financial instruments among permissioned users.

FIG. 4 shows a matrix defining permissioning among five users.

FIG. 5 illustrates a preferred messaging protocol for the system of FIG. 3.

FIG. 6 illustrates message flow in a network including three users and an ECN.

FIG. 7 shows an initiating user and a pair of responding users.

FIGS. 8(a) and 8(b) show an illustrative flow chart for a network process of FIGS. 5 and 6.

FIG. 9 shows an exemplary flow chart for a method of addressing emerging liquidity

FIG. 10 shows an exemplary flow chart for another method of addressing emerging liquidity.

FIG. 11 shows a flow chart for another embodiment of the present invention.

FIG. 12 shows a flow chart for yet another embodiment of the present invention.

FIG. 13, shows the interface of FIG. 2, modified to include additional execution instructions for user-to-user direct trades.

FIG. 14 illustrates the interaction between two users and an ATS in accordance with another embodiment of the present invention.

FIG. 15 is a flow chart illustrating a system for routing orders for financial instruments based upon undisclosed liquidity in accordance with an embodiment of the present invention.

FIG. 16 is a flow chart exemplifying the interaction between two users and an ATS in accordance with another embodiment of the present invention

### DETAILED DESCRIPTION OF THE PREFERRED EMBODIMENTS

In connection with transactions for financial instruments such as securities, it is known to place an order (e.g., to sell, or to buy) that contains a displayed value and a reserve (or hidden) value. In this context, if a user A (for example, a broker or dealer) wishes to buy 20,000 shares of INTC, it may do so by placing a bid for 1000 shares at a given price (52.14) as a NASDAQ market maker (or on to an ATS), while maintaining the remaining 19,000 shares in reserve. Similarly, if user B (for example, another broker or dealer) wishes to sell 40,000 shares of INTC, it may do so by placing an offer for 2000 shares at a given price (e.g. 52.15) as a NASDAQ market maker (or on to an ATS) while maintaining the remaining 38,000 shares in reserve. If the bid/offer was placed with NASDAQ, receivers of level I and II NASDAQ information would know that a bid exits for 1000 shares of INTC at 52.14 and that an offer to sell exists for 2000 shares of INTC at 52.15. However, with the exception of user A, all receivers of this NASDAQ information would be unaware of user A's hidden reserve of 19,000. Similarly, with the exception of user B, all receivers of this NASDAQ information would be unaware of user B's hidden reserve of 38,000. If the bid/offer was placed on an ATS, each ATS member would know that there was a bid for 1000 shares of INTC at 52.14 and that there was an offer for 2000 shares of INTC at 52.15. However, with the exception of user A, all of the ATS members would be unaware of buyer A's hidden reserve of 19,000. Similarly, with the exception of user B, all ATS members would be unaware of buyer B's hidden reserve of 38,000. Therefore, another user, being unaware of the hidden liquidity available in the above-reference reserves, might only take the offer for 2000 shares at 52.15, or hit the bid for 1000 shares at 52.14, or may trade through to the next price level, despite the fact that he or she was interested in purchasing/selling a greater number of shares at the respective prices.

Another disadvantage of the systems described above is that they require the use of a trade execution entity such as an exchange or ATS (such as an ECN) to execute trades. Thus, when broker/dealer A wishes to buy 2000 shares of DELL at a limit price of 52.10, and broker/dealer B wishes to sell 2000 shares of DELL at a limit price of 52.05, they must pay fees to their ATS (or exchange) in order to execute the trade, and in the process, their respective bids and offers become “visible” (i.e., disclosed quantities) to other members of the ATS (or exchange). As described above, it is possible for broker/dealer A to trade directly with broker/dealer B. In general, such “direct” trades are implemented using auto-execution engines developed by third parties or proprietary auto-execution engines. Such auto-execution engines are limited in application however. Specifically, these auto-execution engines are used by market makers, and are typically set as desired to automatically execute incoming market orders for selected securities up to a maximum number of shares and the broker which sent the message sends an execution request message to only one broker at a time.

In accordance with an embodiment of the present invention, users/traders can automatically buy and sell financial instruments (preferably in the form of undisclosed liquidity quantities) amongst themselves pursuant to bilateral agreements (hereinafter user-to-user direct trades) under their capabilities as brokers. Such user-to-user direct trades provide a number of advantages. For example, such trades allow the user to select their trading partners, the trades will not affect the market price of the traded securities, and the trades allow the user to reduce or eliminate fees paid to ECNs or exchanges.

In accordance with this system and method, users (e.g., broker dealers) of the system enter into bilateral or multilateral agreements for user-to-user direct trades. As such, each user of the system has one or more other permissioned users with which it can enter into user-to-user direct trades. The system monitors orders for financial instruments from a user before these orders are sent to any trade execution entity such as an ECN or exchange. Each order includes a side component (e.g. buy or sell), a symbol component (e.g., Applied Materials), a first price per unit component (e.g., $54.14) and a first unit quantity (e.g. 1000 shares). The system also monitors reciprocal orders for financial instruments from each of the permissioned users of that user before the reciprocal orders have been sent to any trade execution entity. The reciprocal order includes the same symbol component, an opposite side component, a second price per unit component, and a second unit quantity, and the first and second price per unit components have overlapping values. For example, if the order is a bid to buy 100 shares of DELL at $25.65, an offer to sell DELL at $25.65 (or less) would be a reciprocal order having an overlapping price per unit component. For each reciprocal order, the system sends an execution message to the corresponding permissioned user confirming trade execution if at least a portion of the first quantity has not previously been sent to any trade execution entity or previously executed with any permissioned user. Trade execution can then be reported for example, by the first user, the second user, or a third party reporting service.

As described in more detail below, in certain preferred embodiments of the present invention, the system is implemented via software processes associated with each user. For example, the permissioned users could implement the above process using intention to trade messages, order messages, and execution messages. In this embodiment, a software process associated with each user is configured to receive orders (e.g., ticket orders, as described below) from its user, to transmit intention to trade messages to its permissioned users, to receive order messages from its permissioned users, and to transmit execution messages to its permissioned users. For example, a software process associated with broker dealer A may receive from broker dealer A (or, a trader at broker dealer A) the order (e.g., a ticket order as described below) to buy 100 shares of DELL at 25.65. The software process could then send intention to trade messages to the permissioned users of broker dealer A indicating that broker dealer A is willing to buy 100 shares of Dell at 25.65. The software process associated with broker dealer B (one of the permissioned users) similarly receives, from broker dealer B, an order to sell 100 shares of DELL at 25.60. Since the software process associated with broker dealer B received the intention to trade message from broker dealer A, it can respond with an order message to broker dealer A indicating that broker B will sell 100 shares of DELL at 25.60. Assuming that the 100 shares of DELL are still available, the software process on broker dealer A will respond with an execution message. It should be noted that the order message is a binding bid/offer (e.g, a liability order) which expires at a specified time if not accepted by a responsive execution message. In contrast, the intention to trade merely reflects an indication of interest in the trade, and the initiator of the intention to trade message is not required to accept the responsive order message. In preferred embodiments of the present invention, however, the initiator of the intention to trade message must accept a responsive order message, if it has not yet executed the order which formed the basis of the intention to trade message.

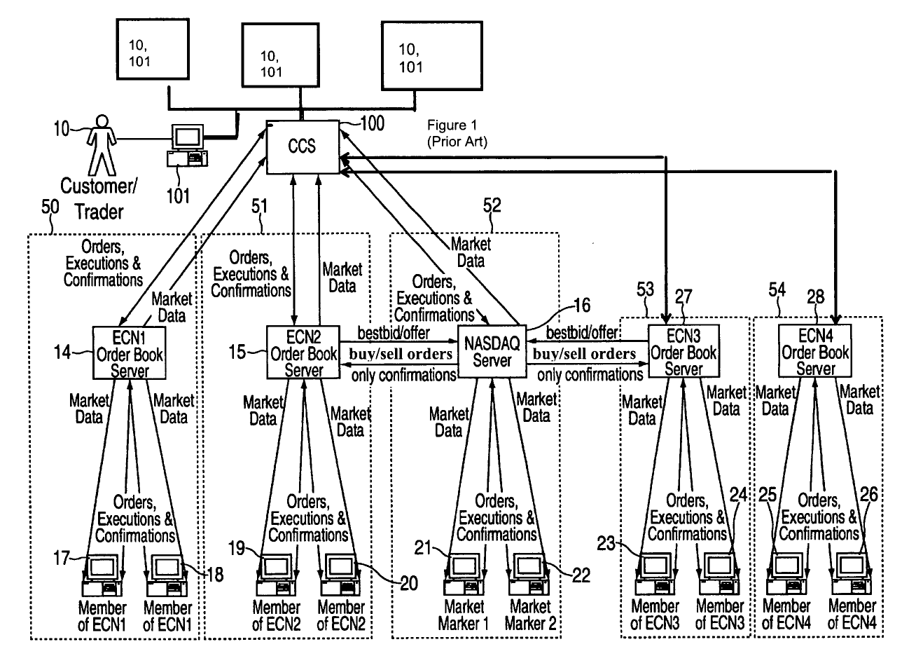

To facilitate the discussion of the present invention, it is helpful to consider the general prior art architecture in connection with which the embodiments of the present invention may be used. It should be understood, however, that other architectures may also be used. Referring to FIG. 1, four user/traders 10 use several ECNs and NASDAQ to do their trading. In this simple example, each trader 10 is a member of two ECNs, ECN1 50 and ECN2 51, and one electronic exchange, NASDAQ 52, all of which are accessed via trading a respective terminal 101. A consolidating computer system (CCS 100) is connected to each terminal 101 and to ECN1's order book server 14, ECN2's order book servers 15, and the NASDAQ server 16. In turn, ECN1's order book server 14 is connected to the trading terminals of its other members 17 and 18 and ECN2's order book server 15 is connected to its other member's trading terminals 19 and 20.

Unlike ECN'S, NASDAQ has market makers and users. Market makers are responsible for maintaining the market in particular securities. Market makers post their best bid and offer from their proprietary and customer orders for each security in which they make a market to NASDAQ. Market makers accept orders from users and other market makers, and can execute orders with other market makers and ECNs. When executing with a market maker, users may only buy stock at the market makers' displayed offer price and sell stock at the market makers' bid price, i.e., take (lift) the offer or hit the bid.

ECN1 50 is a closed network that does not interact with other ECNs or NASDAQ. ECN1's order book server interacts with trading terminals 101 (coupled to CCS 100) and with its trading terminals 17 and 18 (which are not coupled to CCS 100) in the same manner. The ECN1 order book server 14 exchanges orders, executions and confirmations with its trading terminals 17 & 18 (and via CCS 100, trading terminals 101) and based on this information supplies market data to each of its trading terminals 101, 17 and 18. In other words, each of trading terminals 101, 17 and 18 supplies its orders to the ECN1 order book server 14. ECN1's order book server 14 aggregates this information to construct ECN1's order book, which is in turn, supplied to each of its trading terminals 101, 17& 18.

ECN2 51 similarly interacts with its trading terminals 101, 19 and 20. However, ECN2 51 is integrated with NASDAQ. ECN2 51 delivers its best bid and offer for each security traded on it to NASDAQ to be displayed by NASDAQ in combination with the best bid and offer from other conforming ECNs and market makers. ECN2 51 and its members posting its best bid or offer must accept hits from users of NASDAQ 52 corresponding to ECN2 51 posted best bid and offer. Depending on whether it is able to execute those orders (i.e. if the best bid or offer is still available), ECN2 51 will send confirmations or rejections to NASDAQ 52. NASDAQ 52 does not receive ECN2's full order book, only the best bid and offer for each security. On the other hand, a conforming ECN that is integrated with NASDAQ 52 does not receive pricing information from NASDAQ 52 and thus can not make NASDAQ market data available to its members. However, an individual member of an ECN may, if entitled as a broker/dealer or otherwise, separately purchase a feed from NASDAQ.

Traders 10 are not members of ECN3 53 consisting only of order book server 27 and trading terminals 23 and 24. ECN3 53 is a conforming ECN integrated with NASDAQ 52, thus trader 10 will only be able to view information about ECN3 53 on trading terminal 101 and this information will only be the best bid and offer for a security from ECN3 53.

Finally, traders 10 are not members of ECN4 54 consisting only of order book server 28 and trading terminals 25 and 26. ECN4 54 is not a conforming ECN that is integrated with NASDAQ. Thus traders 10 do not have access to an ECN4 trading terminal and will not be able to view information about ECN4 54 on trading terminal 101.

For purposes of illustration, ECN3 and ECN4 are shown connected to CCS 100 via a single double-arrowed line, to schematically indicate that ECN3 and ECN4 are accessed by the CCS 100, but not by users 10. They may, however, be accessed by other users of CCS 100, who are members of ECN3 and ECN4 respectively.

The CCS 100 performs a number of interrelated functions that may be carried out on one computer or a network of computers. CCS 100 collects orders from each ECN (ECN1 50, ECN2 51, ECN3 53 and ECN4 54)and electronic exchanges (NASDAQ 52), and distributes a composite order book to the user/traders according to each user/trader's memberships in the ECNs and rights to use an electronic exchange. Thus, a user/trader 10 may only receive a subset of the complete order book compiled by the CCS 100 corresponding to where the user/trader 10 is permissioned. In this example user/trader 10 has access to ECN150 and ECN251 and NASDAQ 52, but not ECN3-53 (except through NASDAQ 52) and ECN4-54.

The customized order book is displayed on the user/trader's terminal 101 normally organized by security and price. This allows the user/trader 10 to compare the information from all of the ECNs 50 and 51 of which it is a member; NASDAQ's market makers 21 and 22; and ECN3 53 best bid an offer in a single display to simplify the decision process. Analytical calculations from this data may also be displayed and used to aid the trader in making buy/sell decisions.

At trading terminal 101, the user/trader may filter and/or customize the data displayed based on trading preferences. These features allow the user/trader to remove orders that are less desirable and view the data in a format optimized for their trading activity. As an example, a user/trader may specify a minimum quantity for a bid or offer to be displayed. As another example, the user/trader may customize the display by specifying a minimum price granularity (the smallest allowable increment) for displaying bids or offers (e.g. 1/32 of a dollar, $0.01, etc.), which will cause prices with greater granularity to be rounded as appropriate.

When a user/trader 10 wishes to place an order, he/she may use trading terminal 101 to send the order to the CCS 100. Based on parameters indicated by the user/trader, CCS 100 will determine when and where to place the order. For example, the CCS 100 could break up a single order, routing it to more than one ECN and/or electronic exchange. It should be noted that although the CCS 100 is shown in FIG. 1 as a single, central, computer, it may in practice be implemented as a network of computers, and, moreover, certain of its functions may also be performed by the terminal 101.

There are a variety of types of orders that a user/trader 10 may wish to place, and the following examples are meant to demonstrate some of the uses of the embodiments of the present invention. For example, a limit order is an order type in which the user/trader specifies minimum sales price (in the case of an offer) or a maximum purchase price (in the case of a bid) in addition to the number of shares which the user/trader wishes to sell or buy. In contrast, a market order is an order type in which the user/trader agrees to buy or sell a specified number of shares at the best price available at the time the order is executed. Other types of orders will be discussed in more detail below. In the system of FIG. 1, when a user/trader 10 wishes to place an order, the order is first sent from the terminal 101 to the CCS 100, and then sent from the CCS 100 to, for example NASDAQ 52 or one of ECNs 50-51. In the context of the present invention, the term ticket order will be used to refer to orders sent from the terminal 101 to the CCS 100, the term external order will be used to refer to orders sent from the CCS 100 to NASDAQ or an ECN, and the term order will be used to generically refer to either or both the ticket order and the external order. In many cases, there will be a one-to-one relationship between the ticket order and the external order. However, in some cases, a single ticket order may be divided by the CCS 100 into a plurality of external orders.

A user interface for placing orders will now be described in connection with the LAVA TRADING FLOORS® software available from Lava Trading, Inc. It should be appreciated, however, that while the user interface described herein is preferred, any user interface could be used to place orders in connection with the embodiments of the present invention. Moreover, orders may be placed without the use of any user interface. For example, orders may be placed automatically via software without any user interaction or user display.

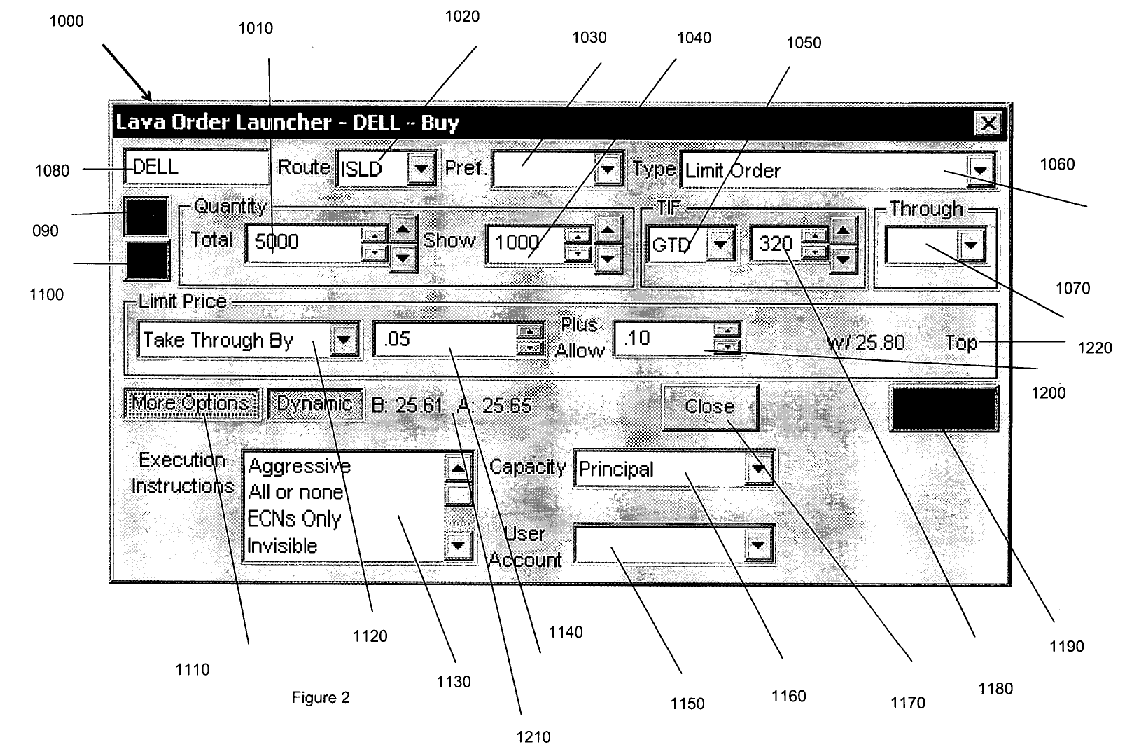

FIG. 2 shows a “Lava Order Launcher” screen 1000 for the above-referenced software. It should be noted that FIG. 2 is used to illustrate a large number of fields and options that are available to a user from the “Lava Order Launcher”, and that not all of these fields and options will be displayed or be available for all order types. Moreover, it should be appreciated that the Lava Order Launcher screen of FIG. 2 is used merely to illustrate a possible graphical user interface for placing orders, and that other configurations may alternatively be used. In any event, referring to FIG. 2, the screen includes: a symbol field 1080 for identifying the security to be traded; a route field 1020 drop-down box which indicates the route to which the order will be sent (in this case, Island, an ECN), and a “type” field 1060 which indicates the order type (in this case, a limit order). A quantity section includes a “total” field 1010 which indicates a total number of shares to be traded; a “show” field 1040 which, when used, indicates the amount of shares the user wishes to be “shown” as being traded to other users who receive information regarding the order from, for example, NASDAQ or an ECN (i.e., the disclosed liquidity). This feature is used for specifying a reserve quantity in an order, as described in more detail below. A time in force (TIF) field includes a drop-down selection box 1050 and a time field 1080 which together, define an expiration time for the order. A limit price field includes a drop down selection box 1020 (in this case Take through by), a price offset field 1040, a discretion field 1200, and a calculated limit price 1220 (in this case, 25.8, which equals the inside offer (25.65) minus the offset (0.05) minus the discretion (0.10)). A through field 1070 allows the user to be able to trade anonymously by selecting an alternate firm to be the executing broker dealer for the indicated trade. This field can be used with any order type. A buy button 1090, when selected (as shown), indicates that the order is a buy order (or bid). A sell button 1100, when selected, indicates that the order is a sell order (or offer). The current inside “bid” and “ask” (i.e., offer) price are displayed in field 1210 (in this case, a bid of 25.61 and an offer of 26.65). A close button 1170 is provided, which, when executed, closes the window without executing any trade. An execute button 1190 (in this case, indicating a buy order) causes the order to be executed (i.e., sent). When the more options button 1110 is selected (as shown), the execution instructions field 1130, the capacity field 1160, and the user account field 1150 are displayed.

The “pref” field 1030 is used to indicate a specific counterparty with which the user would like to trade, if the trade execution entity supports such a feature. For example, Nasdaq would offer this field for their SelectNet execution system so that a user can indicate the specific broker dealer with which they would like to trade. It should be noted that if the user is routing an order directly to an ECN, this field would generally not be used as counterparties on ECNs are, in current ECN systems, anonymous.

In any event, returning to FIG. 2, there are preferably 8 options for the selection box 1120 for buy limit orders, and 8 options for the selection box 1120 for sell limit orders. The options for buy limit orders preferably include: 1) “High Bid by”, to post a bid at the inside bid price (e.g., 25.61) plus the amount indicated in field 1140; 2) “Join Bid” to post a bid at the inside bid price; 3) “Below Bid by” to post a bid at the inside bid price minus the amount indicated in field 1140; 4) “Bid below Offer by ” to post a bid at the inside offer price (e.g., 26.65) minus the amount indicated in field 1140; 5) “Bid” to post a bid at the amount indicated in field 1140 (Default is the inside bid price); 6) “Take Offer” to post a bid at the inside offer price; 7) “Offer” to post a bid at the amount indicated in field 1140 (Default is the inside offer price); and 8) “Take through by” to post a bid at the inside offer plus the amount indicated in field 1140. The options for sell limit orders preferably include: 1) “Low Offer by”, to post an offer at the inside offer price (e.g., 25.65) minus the amount indicated in field 1140; 2) “Join Offer” to post an offer at the inside offer price; 3) “Above Offer by” to post an offer at the inside offer price plus the amount indicated in field 1140; 4) “Offer over Bid by” to post an offer at the inside bid price plus the amount indicated in field 1140; 5) “Offer” to post an offer at the value in field 1140 (Default is the inside offer price); 6) “Hit Bid” to post an offer at the inside bid price; 7) “Bid” to post an offer at the amount indicated in field 1140 (Default is the inside bid price); and 8) “Hit through by” to post an offer at the inside bid price minus the amount indicated in field 1140.

As discussed below, for a reserve limit order, the show field 1040 and total field 1010 can be used to specify a reserve amount (reserve=total−show) and a displayed amount (show). For a hidden limit order, the user selects more options 1110, and then selects “invisible” from the execution instructions field 1130.

Another type of order is a “pegged” order. A “pegged” order allows the user to “peg” an ECN order to the same or opposite (i.e., reciprocal) side so that your order will move with the inside price. To enter a pegged order using the Order Launcher of FIG. 2, for Route 1020, enter an ECN, for Order Type 1060, select “Pegged Order” and, in the Quantity field, enter the total quantity 1010 (and show quantity 1040 if defining a reserve). The options for the selection box 1120 for buy pegged orders preferably include High Bid By, On Bid, Below Bid By, and Bid Below Offer By as described above, and the options for the selection box 1120 for sell pegged orders preferably include Low Offer By, At Offer, Above Offer By, and Offer Over Bid By as described above. In this case, in the “Plus Allow” field, the user may enter a value to set the limit price (top/low value 1220) for this order. If the inside price moves beyond this range, the pegged order will act as a limit order and will not follow the inside past its limit. It will resume ‘pegging” or following the inside price when the inside price moves back within the price range.

Another order type is the sweep order. With a sweep order, a user can specify a total quantity and limit price and the CCS 100 will then pick off all available liquidity within that limit without allowing other users/trader's to know that the user is trying to buy/sell. The sweep will continue to work until filled, cancelled or until it expires based on the user specified duration. To enter a sweep order from the screen of FIG. 2, select buy (field 1090) or sell (field 1100) and select sweep (field 1060). The route 1020 is specified as “CLBK” (Colorbook). The limit price is specified in fields 1120 and 1140. The quantity to be bought or sold is specified in the total field 1010 (show field 1040 is not used since there is no disclosed quantity in this type of order). If “Aggressive” is selected under execution instructions, bids/offers from the same route will be aggregated into one order at the worst displayed price. If“ECNs Only” are selected under execution instructions, orders will only be directed to ECNs. In any event, when the sweep order executes, it will take any liquidity (e.g., offers, if it's a sweep buy order, or bids, if it's a sweep sell order) that is shown as available within the limit specified in 1120, 1140, and 1200. If a Time In Force (TIF) of Immediate or Cancel is used, the entire indicated quantity will be distributed across all market makers and ECNs showing bids/offers within the limit price specified, weighting the quantity to each participant based on their displayed quantity.

To illustrate the sweep order, consider the following example. An order is entered with the following parameters: Dell (field 1080), CLBK (field 1020), sweep (field 1060), Sell (field 1100), 10,000 (field 1010), hit through by (field 1120), 0.02 (field 1140), 24.04 Low (field 1220). At the time the order is entered, the bids shown for Dell are as follows:

TABLE 1

| ECN/Market Maker | Bid | Quantity |
|---|---|---|
| MLCO | 24.05 | 1000 |
| GSCO | 24.05 | 2000 |
| ISLD | 24.05 | 5000 |
| ARCA | 24.04 | 1000 |
| FBCO | 24.03 | 3000 |

CCS 100 will evaluate the above-bids and determine that the highest current bid is 24.05. It will then assess whether there is enough stock at the 24.05. level to fill the order. The following share amounts are calculated: i) 1,000 shares for MLCO ; ii.) 2,000 shares for GSCO ; iii.) 5000 shares for ISLD, for a total of 8000 shares at the 24.05 level. Since this is not enough to fill the 10,000 share order, CCS 100 moves on to the 24.04 level. At this point, the following share amounts are calculated: 1000 shares for ARCA, for a total of 1000 shares at the 24.04 level. The FBCO bid of 3000 shares at 24.03 is below the minimum price specified in the sweep order. Therefore, a total of 9000 shares are sent in an “initial” sweep to the above-referenced ECNs and market makers. If additional bids become available within the specified limit before the TIF (field 1050, 1180) expires, additional sweeps will be executed. It should be noted that other buyers and sellers in the NASDAQ or in the ECNs will be unaware of the existence of the sweep order, or the desire, on the part of the user/trader initiating the sweep order, to execute a sale of 10,000 shares of Dell.

Another type of order is the Lava ColorBook Market Order. This order type acts as a “sweep order” that executes at the current inside price. In other words, it will exhaust the current inside price level before moving to a worse level (e.g., a lower price for sell order, or a higher price for a buy order). If the inside price improves, CCS 100 will immediately move to that level. Like the sweep order described above, it will keep executing until filled or until expiration based on the duration indicated by the user in TIF (fields 1050, 1180). To enter a Lava Market Order from the screen of FIG. 2, select buy (field 1090) or sell (field 1100), select CLBK as the route 1020, “market ” as the type 1060, and enter a TIF in fields 1050, 1180. The security to be bought or sold is entered in field 1080, and the amount of shares in the market order is entered in field 1010. Since it is a market order, nothing is entered in the price fields 1120, 1140, and 1200.

Another type of order is the ColorBook Discretion Order. This order type allows a user to post a limit order to an ECN or exchange and then sweep liquidity within a discretion amount using a reserve quantity. To enter a discretionary order in FIG. 2, an ECN (e.g., ISLD) is selected as the route 1020, Limit Order is selected as the order type 1060, and a total quantity 1010 and show quantity 1040 is entered in the quantity section. A limit price is entered in fields 1120 and 1140, and the discretion amount is entered in field 1200. The “show” quantity 1040 of the order is executed at the limit price, and as it is filled, it is refreshed. At the same time, liquidity within the discretion amount will be bought or sold as a sweep order. As an example, consider a ColorBook Discretion Order to sell 10,000 shares of Dell, with a “show” value of 1000, an offer price of 20.00 and a discretion of 0.10. CCS will issue an offer for 1000 shares of Dell at 20.00 (leaving 9000 shares in reserve). As shares are sold at that price, the offer for 1000 shares will be refreshed from the reserve quantity, and the reserve quantity will be reduced accordingly. In addition, CCS will hit any bids for Dell that are within the discretion amount (e.g., greater or equal to 19.90, the offer price 20.00 minus the discretion 0.10) as a sweep order in an amount up to the amount of the current reserve quantity.

There are also variations on the sweep order, including the Sweep and Post and the Sweep Post Hidden. With the Sweep Post Hidden, after the initial sweep order described above, any unexecuted quantity is divided up and posted as “Hidden limit” orders to all permissioned ECNs that support hidden limit orders. When an ECN receives a “hidden” limit order, it will not display the order to the ECN members. However, if an ECN has a hidden buy/sell order, and a corresponding displayed offer/bid within the limit appears, the ECN will match the orders. The Sweep Post Hidden order is initiated in the same manner as the Sweep Order, except that the type 1060 is Sweep Post Hidden.

With the Sweep and Post, after the initial sweep order described above, any unexecuted quantity is posted to one or more trade execution entities as limit orders at the limit price specified in the sweep order. The user can specify which trade execution entities can be used for the “post” portion of the order (e.g., a particular ECN, ECNs only, etc.). In addition, the user can enter a show quantity and a total quantity if the user wishes the “post” portion of the order to be a reserve quantity order. This order is initiated in the same manner as the sweep order, except that the type 1060 is Sweep-Post, and the show quantity field 1040 is used.

Another type of order is the Colorbook Market and Post order. This order initially performs a Colorbook Market Order with Limit Price, and then executes a “post” with any unexecuted quantity in the same manner as the sweep and post order described above.

Another type of order is a ColorBook Probe Order. A probe order allows a user to look for hidden or reserve quantities by issuing, to ECN's and market makers one at a time, with immediate-or-cancel orders for the full remaining quantity of the order. To enter a probe order from FIG. 2, for route 1020, select CLBK, for type 1060, select Probe, in total 1010, enter the quantity, and in price fields 1120 and 1140 enter the limit price.

As noted above, limit orders can specify a reserve quantity. Although a number of ECNs support such reserve orders natively, others do not. In the discussion that follows, the term “reserve quantity order” will refer to both cases, the term “native reserve quantity order” will refer to orders sent to trade execution entities that support reserve orders natively, and the term “non-native reserve quantity” will refer to orders sent to entities that do not support reserve orders natively. A reserve quantity order is a limit order with specified Show Quantity and a balance or reserve quantity which is hidden or not displayed. As the display quantity is depleted, it is automatically replenished from the reserve. Orders at sizes greater than the displayed size will be filled up to the entire reserve quantity. To enter a reserve quantity order in FIG. 2, for Route 1020, select an ECN, for Type 1060, select “Limit Order”, enter the total quantity in total 1010, and the show quantity in field 1040. The reserve quantity is the Total 1010 minus the Show 1040. The limit price is entered in fields 1120 and 1140. Field 1200 is not used. In the case of a native reserve quantity order, both the displayed quantity (show 1040) and the reserve quantity (total 1010 minus show 1040) are immediately sent to the selected route 1040. In contrast, with a non-native reserve quantity order, the reserve quantity is maintained at CCS 100, which sends successive limit orders to the ECN to maintain the displayed quantity as the reserve quantity is depleted.

It should be appreciated that the order types described above are not meant to be a complete or exhaustive list of the order types provided by the LAVA TRADING FLOOR software. Rather what is described above is a representative list of order types which are helpful in explaining the various aspects of the embodiments of the present invention.

Many of the order types described above result in “undisclosed” liquidity being generated. In the context of the present invention, liquidity is defined as an existing order (e.g., to buy or sell a financial instrument) which has not yet been filled (e.g., accepted by the opposing party to the transaction by being hit or taken). Liquidity may either comprise “displayed” or “disclosed” liquidity which can be seen by other users (e.g., traders), or “undisclosed” liquidity which cannot be seen by other users. The bids listed in Table 1 above represent disclosed liquidity. Examples of “undisclosed” liquidity include the “posted” quantities in sweep post hidden, the reserve quantity in the sweep and post, the reserve quantity in market and post, and the reserve quantity (e.g., total quantity minus show quantity) in pegged orders and native reserve quantity orders. The “show” quantity 1040 in discretion orders and pegged orders are examples of “disclosed” liquidity. In market and limit orders that do not specify a “show” quantity, the “total quantity” 1010 is disclosed liquidity.

As discussed above, in the embodiments of the present invention, the traders can automatically buy and sell undisclosed liquidity quantities amongst themselves pursuant to bilateral agreements (hereinafter user-to-user direct trades). Such user-to-user direct trades provide a number of advantages. For example, such trades allow the user to select their trading partners, the trades will not affect the market price of the traded securities, and the trades allow the user to eliminate fees paid to ECNs or exchanges.

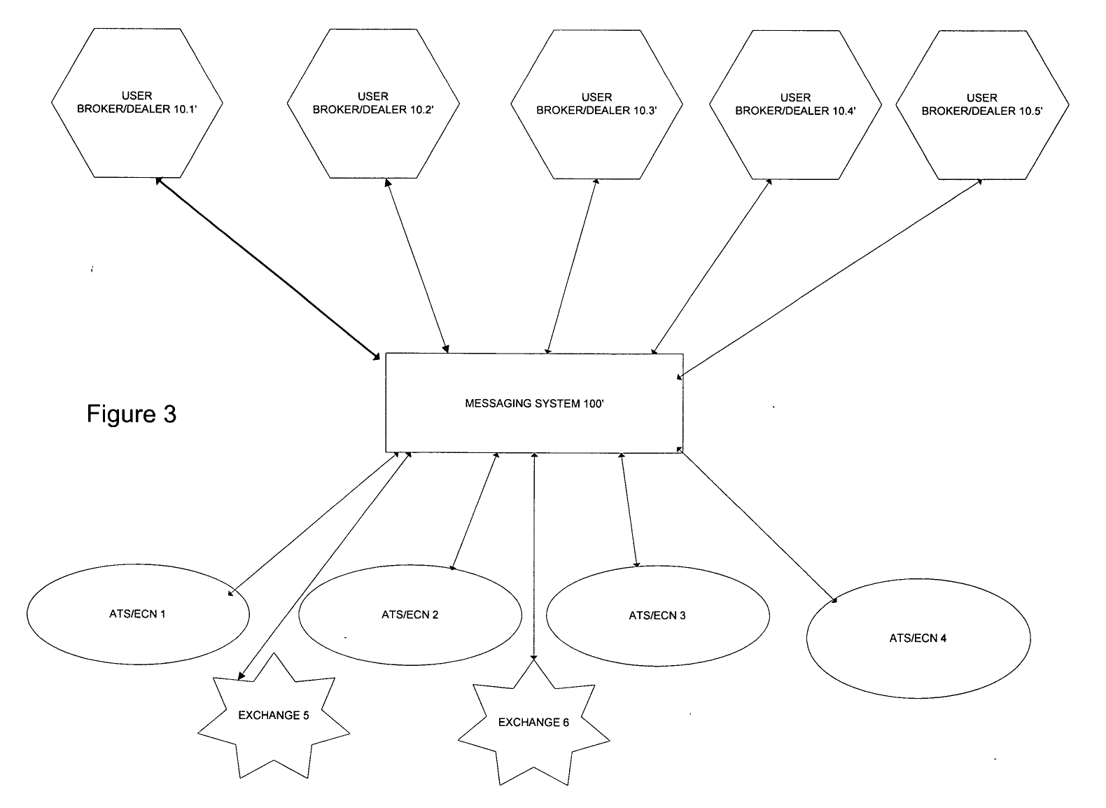

Referring to FIG. 3, in the context of the present invention, a system includes a plurality of users 10.1′ through 10.5′(collectively referred to herein as users 10′), a messaging system 100′, and optionally one or more trade execution entities such as ATS/ECNs 1-4 or Exchanges 5-6. The messaging system 100′ can be implemented in any manner sufficient to achieve the messaging functions described herein. For example, it could be implemented via a central server or via a peer-to-peer network. Alternatively, one or more of the users 10′ could function as server(s).

In certain embodiments of the present invention, the messaging system 100′ further comprises the CCS 100 of FIG. 1, the users 10′ are the users 10 of FIG. 1, and the trade execution entities 1-6 include entities 50-54 of FIG. 1. However, it should be understood that this embodiment of the present invention can be implemented separate and apart from the embodiments described above with regard to FIGS. 1-4.

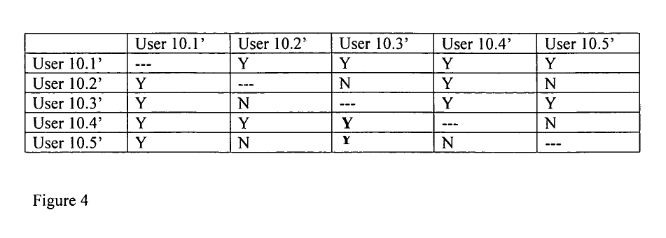

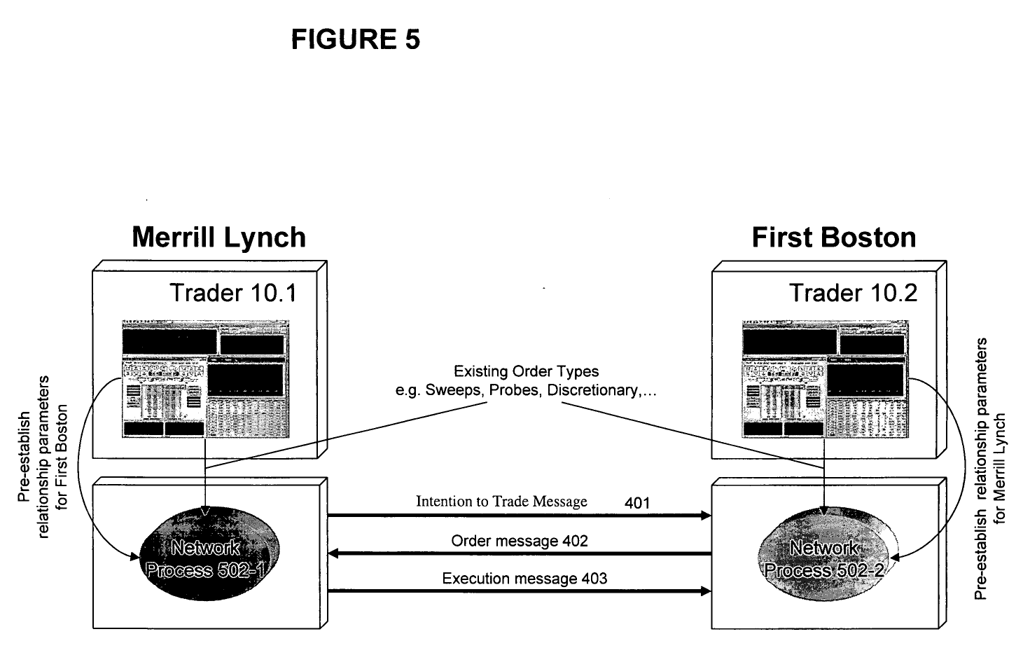

Each user 10′ specifies one or more other users 10′ with which it has agreed to enter into user-to-user direct trades. Referring, for example, to FIG. 4, a matrix is shown which identifies the permissioning between users 10.1′ through 10.5′ of FIG. 5, with a “Y” indicating that a direct user-to-user trade agreement exists between the references users, and with an “N” indicating that it does not. In this example, user 10.3′ has agreements with users 10.1′, 10.4′ and 10.5′. The direct user-to-user trade agreement can take any form, provided that it indicates an agreement between at least two users to enter into direct trades. The agreement may also define other pre-established parameters that govern transactions between permissioned users. These pre established parameters could be used to exclude certain orders generated by the system, specify a maximum size (e.g., number of shares) that can be exposed at any one time; and/or specify a pricing structure to govern user-to-user direct trades.

FIG. 5 illustrates a preferred messaging protocol for the system of FIG. 5 with respect to two illustrative users, first user 10.1′ and second user 10.2′ (in this case, two brokerage firms) for the purposes of buying and selling undisclosed liquidity. In this context, liquidity (e.g., orders) is “undisclosed” if it has not yet been sent to any exchange ATS, or other trade execution entity as a “visible” order. As such, any ticket order, regardless of its order type, comprises “undisclosed liquidity” unless or until an external order is sent to an exchange, ATS, or other trade execution entity (as contrasted with permissioned users). As discussed above, however, in certain embodiments, a SWEEP order (or components thereof) can remain “undisclosed liquidity” even after the corresponding external order is sent to the ATS, exchange or trade execution entity because SWEEP orders are not reflected in the market data and are therefore never “visible” to other users, whereas, in other embodiments, any component of the SWEEP order which has been sent to an ATS, exchange or trade execution entity is not undisclosed liquidity. In any event, each of the users 10.1′ and 10.2′ has a respective network process 502 1 and 502 2. The network processes 502 communicate with each other via the messaging system 100′. A plurality of traders can be connected to each user 10′. For example, user 10.1′ (Merrill Lynch) may comprise hundreds of individual traders or brokers who individually initiate orders for securities. In the example of FIG. 5, a user-to-user trade agreements exists between user 10.1′ and user 10.2′.

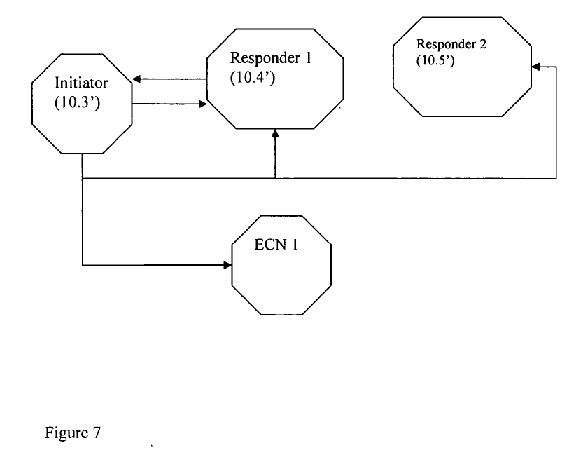

The network processes 502 communicate with one another by Intention to trade messages (ITTs) 401, order messages 402, and execution messages 403. An ITT 401 is used by the network process of an initiating user to notify the network processes 502 of its permissioned users (hereinafter “responding users”) of available undisclosed liquidity. In general, the ITT 401 will indicate the name of the security (e.g. the symbol AMAT for Applied Materials), the “side” (i.e., buy or sell), the limit price for the security (e.g., 45.14), and the number of shares. When the network process on a responding user thereafter receives reciprocal undisclosed liquidity from the responding user, it will see the ITT received from the initiating user and send a responsive order message 402 to said network process 502 of the initiating user. In general, the order message would indicate the side, name of the security (symbol), quantity, and limit price of the reciprocal undisclosed liquidity of the responding user. The order is then confirmed by an execution message 403, for example, sent from the network process 502-1 to the network process 502-2. Reporting of executions could be done by the first network process 502-1, second network process 502-2, or both. It should be noted that although FIG. 7 illustrates an ITT and execution message emanating from network process 502-1, and an order message emanating from network process 502-2, the opposite is also true. In other words, network process 502-2 can transmit ITT and execution messages, and network process 502-1 can transmit order messages (although it is possible to configure a system in which a given network process 502 can only transmit ITT's or only respond to ITTs). Preferably, moreover, each process 502 will check for incoming ITTs from other process 502 that will hit/take the undisclosed liquidity (or portion thereof) before generating its own ITT.

Preferably, each network process 502 maintains information regarding undisclosed liquidity quantities for its corresponding user 10′ that have not been sent to any trade execution entity. In the illustrative example of FIG. 7, each user 10′ is initiating trades through a user interface (such as that included in the LAVA TRADING FLOOR program), and each network process 502 maintains information regarding undisclosed liquidity quantities generated by the above referenced SWEEP orders, PROBE orders, DISCRETIONARY orders, and any other order type provided that the order has not yet been sent to any trade execution entity. For example, if user 10.1′ issued a BUY SWEEP of 1000 shares of DELL with a limit price of 45.13 (e.g., a ticket order), and 800 shares of the BUY SWEEP order had not yet been placed with any trade execution entity (e.g. ATS or exchange), then network process 502-1 would maintain information indicating that user 10.1′ was holding undisclosed liquidity in the form of a buy order for 800 shares of DELL at a limit price of 45.13. Similarly, if user 10.2′ issued a SELL SWEEP of 500 shares of DELL with a limit price of 45.10, and 300 shares of the SELL SWEEP order had not yet been placed with any trade execution entity (e.g. ATS or exchange), then network process 502-2 would maintain information indicating that user 10.2′ was holding undisclosed liquidity in the form of a sell order for 300 shares of DELL at a limit price of 45.10.

Continuing the above example, assume that the BUY SWEEP order is entered by user 10.1′ before the SELL SWEEP order is entered by user 10.2.′ Network process 502-1 will send an ITT message 401 to network process 502-2. The ITT message 401 includes information which indicates that network process 502-1 (or user 10.1′) is willing to buy 800 shares of DELL at a limit price of 45.13. When network process 502-2 receives the SELL SWEEP order for 300 shares of Dell at a limit price of 45.10, from user 10.2′, it will see the ITT 401, and transmit an order message 402 to the network process 502 1. In this case, the order message 402 would include information indicating that network process 502-2 (or user 10.2′) is sending an order (preferably an immediate or cancel order) to sell 300 shares of Dell at the limit price of 45.10. Assuming that network process 502-1 still has available shares from the BUY SWEEP order, it will execute the trade in an amount up to 300 shares. Network process 502-1 will then send an execution message 403 confirming the trade. The execution message will indicate number of shares executed and the price.

Generally, the user-to-user trade agreement discussed above will also set forth the pricing structure which governs trades. Alternatively, the pricing structure could be set on a system wide basis. In any event, the pricing structure might be implemented as follows:

1) if the limit price of the Buyer's Order is less than or equal to the Inside Bid Price, the trade is executed at the Buyer's limit price;

2) if the limit price of the Seller's Order is greater than or equal to the Inside Offer Price, the trade is executed at the Seller's limit price;

3) Otherwise, the trade is executed at ((the lower of the Buyer's Limit Price and the Inside Offer Price) plus (the higher of the Seller's Limit Price and Inside Bid Price)) divided by 2.

If the pricing structure described above were used, and the inside bid price was 45.11 and the inside offer price was 45.12, the shares would be sold at (45.12+45.11)/2=45.115. Reporting could be performed by network process 502-1, 502-2 or both (e.g., one party could report both sides of the trade, each party could report its own side, or each party could report the others side).

Alternative pricing structures could also be implemented. For example, the pricing structure could be implemented by having the responding user incorporate a discount into orders sent in response to an ITT. The discount could take many forms, including, for example, a set discount (e.g. $0.02) or as a percentage (e.g. 0.3% of the responding user's order price). Similarly, the pricing structure could be implemented by having the initiating user incorporate a discount into the share prices sent in the ITT. Combinations of the above-structures could also be used.

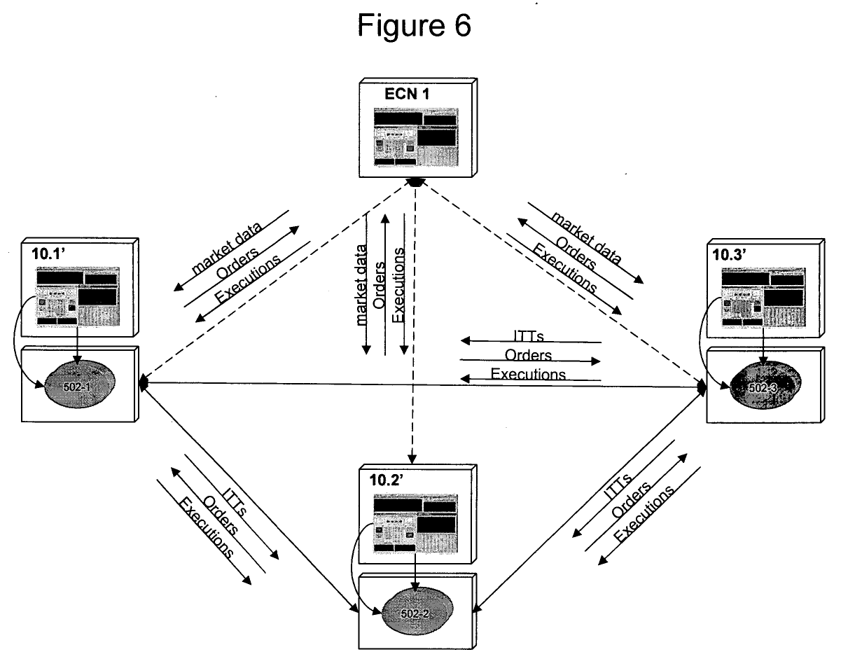

FIG. 6 illustrates message flow in a network including three users 10.1′, 10.2′, and 10.3′, and an ECN 1. As illustrated, the ECN 1 functions in a conventional manner, transmitting market data to each of the users 10.1′, 10.2′, 10.3′, accepting orders messages from these users, and sending responsive execution messages when the order has been executed. In this example, each of the users 10.1′, 10.2′, 10.3′ has permissioned each other one of the users 10.1′, 10.2′, 10.3′. As such ITTs issued from user 10.1′ will be routed to user's 10.2′ and 10.3′, ITTs issued from user 10.2′ will be routed to user's 10.1′ and 10.3′, and ITTs issued from user 10.3′ will be routed to user's 10.1′ and 10.2′.

As described above, the network processes 502 maintain information regarding undisclosed liquidity quantities generated by their respective user's orders which have not been sent to trade execution entities such as ECN 1. The quantities specified in these orders can be distributed over one or more traders and ECNs. For example, an order generated by a trader at user 10.1′ (e.g., a SWEEP order) may be filled by sending a portion of the ordered quantity to an ECN 1 based upon the market data (i.e. visible liquidity), and the remainder to user 10.2′ and/or 10.1′ as ITTs 401 and/or order messages 402. As a further illustration, let us assume that network process 502-1 of user 10.1′ has 800 shares of undisclosed liquidity, and it receives an ITT 401 from network process 502-2 indicating that user 10.2′ has 500 shares of reciprocal undisclosed liquidity and an ITT 401 from network process 502-3 indicating that user 10.3′ has 100 shares of reciprocal undisclosed liquidity. Network process 502-1 could then send an order 402 to network process 502-2 for the 500 shares of reciprocal undisclosed liquidity, send an order 402 to network process 502-2 for the 100 shares of reciprocal undisclosed liquidity, and then send an ITT 402 to network processes 502-2 and 502-3 for the remaining 200 shares of undisclosed liquidity.

Preferably, the network processes 502 reside on their respective users computer (e.g., a First Boston server). However, the network process could alternatively reside on a remote central server such as CCS 100 or be distributed over a network of remote servers.

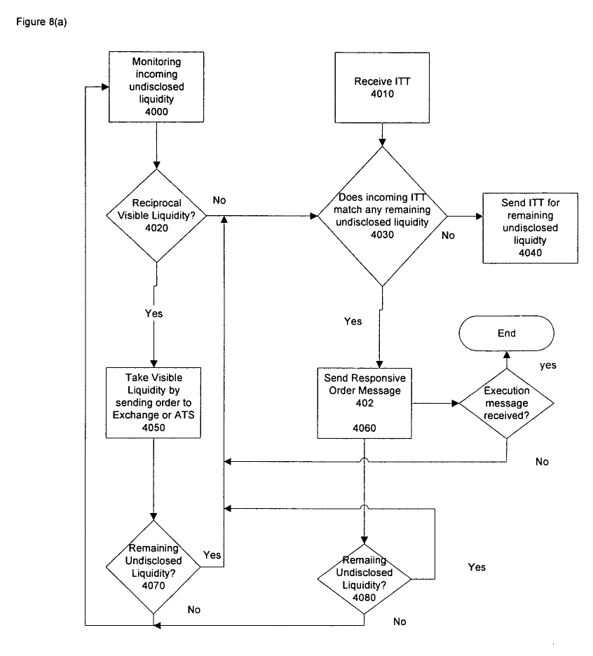

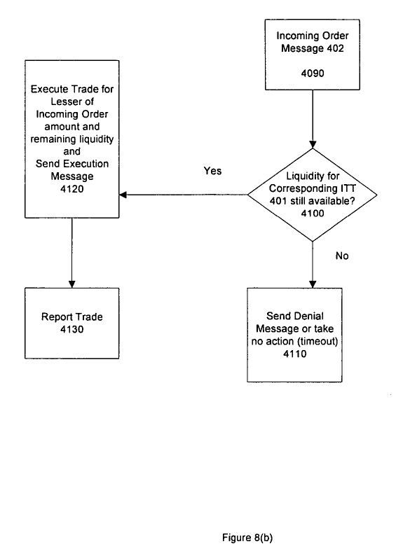

FIGS. 8(a) and 8(b) show an illustrative flow chart for a network process 502 of FIGS. 5 and 6. Each network process monitors the orders generated by its respective user 10 for undisclosed liquidity (step 4000), and determines whether there is reciprocal visible liquidity (step 4020) based upon the market data. If reciprocal visible liquidity exists, then the process hits/takes that liquidity by sending an order to the corresponding ATS/exchange (step 4050) as illustrated in the dashed lines in FIG. 8. If no reciprocal visible liquidity was found in step 4020, or if the visible liquidity found was less than the undisclosed liquidity (step 4070, yes), the process will attempt to trade the remaining undisclosed liquidity via user-to-user direct trades.

In this regard, the process 502 receives incoming ITTs 401 from its permissioned users in step 4010. In step 4030, the process will determine whether the remaining undisclosed liquidity (from steps 4020 and/or 4070) has reciprocal undisclosed liquidity in the incoming ITTs 401 (i.e., do the incoming ITTs “match” the remaining undisclosed liquidity). If there is a match, then the process will send a responsive order message 402 to the user who generated the matching ITT (step 4060). If no matching undisclosed liquidity was found in step 4030 (No), or if the matching undisclosed liquidity found was less than the undisclosed liquidity (step 4080, yes, and step 4030, No), the process sends an ITT 401 for the remaining undisclosed liquidity to each of its permissioned users (step 4040). It should be noted, however, that sending the order message 402 in step 4060 does not guarantee that the trade will be executed. It is possible, for example, that another user 10′ has already responded to the ITT with an order message, or that the user 10′ which generated the ITT has already filled the order because of emerging visible liquidity (discussed below). Therefore, if a responsive execution message 403 is not received prior to the expiration of the order (step 4065), the process will return to step 4030. Preferably, the order message 402 is an “immediate or cancel” order.

Turning to FIG. 8(b), in step 4090, the process 502 also receives incoming order messages 402 for the ITT 401 s which it previously sent to permissioned users in step 4040. When an incoming order message is received, the process determines whether the undisclosed liquidity underlying the corresponding ITT 401 is still available (step 4100). If it is available (step 4100, yes), then the process executes the trade for the lesser of the number of shares requested in the order message 402 and the remaining shares of the undisclosed liquidity underlying the corresponding ITT 401 (step 4120). If it is the entity responsible for reporting, the process then reports the trade (step 4130) to the appropriate exchange in a conventional manner. Preferably, the order message 402 is an immediate or cancel order, and therefore, the process need not take any action if the undisclosed liquidity is now unavailable (step 4100, no). However, if desired, the system can be implemented in a manner which requires the process generating the ITT 401 to respond to orders 402 with either an execution message 403 confirming the trade, or a denial message indicating that the trade was not made (step 4110).

In accordance with certain embodiments of the present invention, the system is also configured to respond to emerging liquidity in ECNs or exchanges. As an example, it is helpful to consider the illustration of FIG. 7. An initiating user (e.g. 10.4′) requests a SWEEP BUY order for 60,000 shares of DELL through 45.54. The initiating users network process 502 (which, for example, may be on the Initiator's system, or on remote server(s)) determines that only 20,000 shares are visible at that price. In this case, the 20,000 shares are available from ECN 1. The network process 502 at the initiator therefore takes the 20,000 shares at ECN 1 (e.g., by sending an order to the ECN in a conventional manner), and sends intentions to trade (ITT) to responder 1 (user 10.5′) and responder 2 (user 10.6′), the users of the system that the initiator has permissioned for direct trading of undisclosed liquidity. In this case, responder 1 thereafter has an overlapping SELL order which has not been sent to any trade execution entity. Therefore, responder 1 sends an order message 402 to the initiator, and the initiator responds with an execution message confirming that the trade has been executed. The trade is then reported to NASDAQ by the initiator (alternatively, the trade could be reported by the responder, or by both). In addition, ECN 1 confirms the sale of the 20,000 shares, and reports the sale to NASDAQ in a convention manner. This process can be implemented, for example, in the manner described above in FIGS. 8(a) and 8(b).

There are, however, a number of contingencies that could change this process. For example, it is possible that before responder 1 sends its order message 402, additional visible liquidity could become available in the external marketplace (e.g., the ECN1). Moreover, it is possible that when the initiator attempts to take visible liquidity from ECN 1, that the shares will no longer be available.

Taking the first hypothesis, assume that in the above example, prior to receiving the order message from responder 1, 30,000 additional shares of DELL at 45.54 become available at ECN 1. Upon determining this, the initiator can take the 30,000 shares from ECN 1, and modify the ITT share amount to 10,000 shares. This can be implemented in a variety of ways, keeping in mind that there is no guarantee that the initiator can successfully take the 30,000 shares from ECN 1.

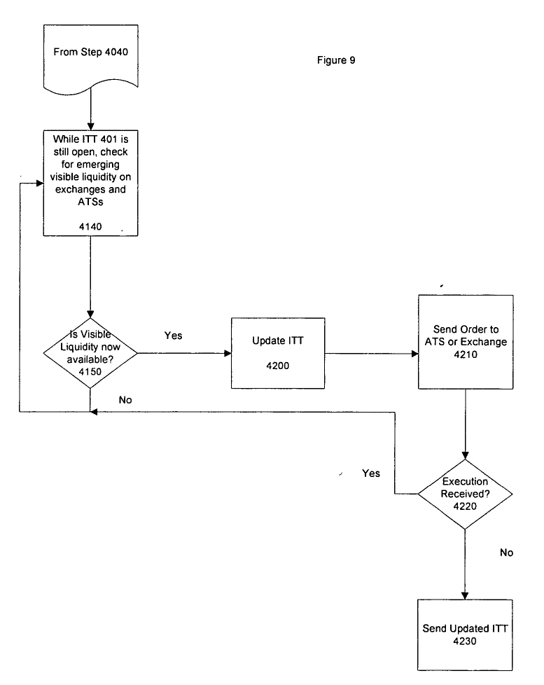

For example, upon determining that the 30,000 shares are available from ECN 1 , the initiator can notify responder 1 and responder 2 that the ITT share amount is modified to 10,000 shares, and then take the 30,000 shares from ECN 1. If ECN 1 executes the trade for 30,000 shares, the process then continues as described above in connection with FIG. 20. If ECN 1 does not execute the trade for 30,000 shares, then the initiator sends a message to responder 1 and responder 2 to modify the ITT share amount to 40,000 shares (assuming that no shares were sold by the ECN). An exemplary flow chart for this implementation is shown in FIG. 9. After step 4040 of FIG. 8(a), and until all of the undisclosed liquidity underlying the ITT 401 is successfully traded, the process monitors the market data for visible liquidity on the ATSs and exchanges which matches (i.e. is reciprocal to) the ITT 401. If reciprocal visible liquidity is found (step 4150, yes), then the process sends an updated ITT 401 to its permissioned users (step 4200) and then sends an order to the corresponding ATS or exchange to take (or hit) the visible liquidity (step 4210). In this regard, if the reciprocal visible liquidity is greater than or equal to the remaining undisclosed liquidity underlying the ITT 401, then the updated ITT 401 will simply cancel the ITT. If the reciprocal visible liquidity is less than the remaining undisclosed liquidity underlying the ITT 401, then the updated ITT 401 will indicate a share amount which is equal to the difference between the remaining shares of undisclosed liquidity underlying the ITT and the shares of reciprocal visible liquidity. If an execution message is received in response to the order of step 4210 prior to expiration of the order (step 4220, Yes), then the process returns to step 4140. If not, the process sends another updated ITT (step 4230) which increases the share amount of the ITT by the number of shares of the unexecuted (e.g., canceled) order.

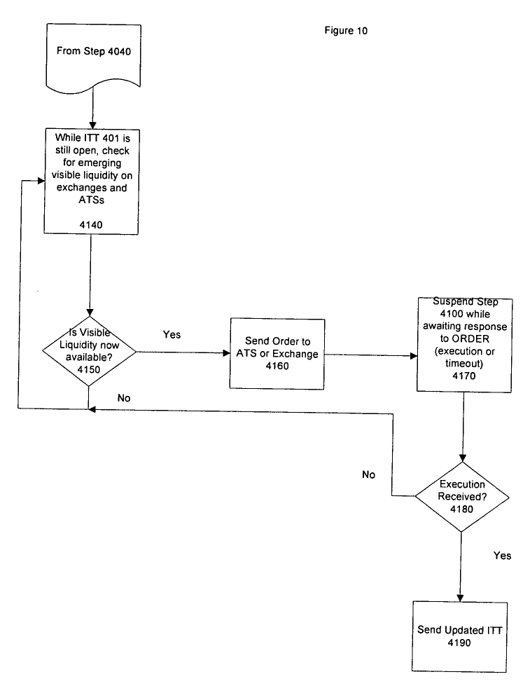

As another alternative, the initiator can take the 30,000 shares from ECN 1, and delay sending any execution messages to responder 1 until the initiator has confirmed that the ECN 1 has executed the trade. Preferably, there is a maximum delay that the initiator can impose prior to executing (or denying) the liability order message from a responder. This solution increases the probability that the initiator can successfully fill its order, but imposes a delay on the responder's orders. An exemplary flow chart for this implementation is shown in FIG. 10. Steps 4140 and 4150 proceed in the manner set forth above with regard to FIG. 9. If reciprocal visible liquidity is found (step 4150, yes), then the process sends an order to the corresponding ATS or exchange to take (or hit) the visible liquidity (step 4160). The process then suspends step 4100 of FIG. 8(b) while it awaits a responsive execution message 403 (step 4170). If the execution message is received (step 4180, Yes), then the process sends an updated ITT to its permissioned users (step 4190). In this regard, if the reciprocal visible liquidity is greater than or equal to the remaining undisclosed liquidity underlying the ITT 401, then the updated ITT 401 will simply cancel the ITT. If the reciprocal visible liquidity is less than the remaining undisclosed liquidity underlying the ITT 401, then the updated ITT 401 will indicate a share amount which is equal to the difference between the remaining shares of undisclosed liquidity underlying the ITT and the shares of reciprocal visible liquidity. Preferably, if an execution message is not received in a predetermined period of time (e.g., if the order is not an immediate or cancel order, the corresponding cancellation time of the order), the process returns to step 4140, and step 4100 is allowed to proceed (step 4180, No).

In the above embodiments, trade execution is performed by the originating user and trade reporting is performed by the originating user or the responding user. However, trade execution and reporting for the entire system (or a portion thereof) could alternatively be delegated to another entity to provide anonymity to the originating and responding users. That entity could be an ECN or one of the users for example. A single entity could provide execution and reporting for all user-to-user trades of undisclosed liquidity in the system, regardless of the originating or responding users. Alternatively, the executing and reporting could be distributed among a number of entities, for example, on a round-robin basis. The appropriate entity could be selected on a temporal basis (e.g. switching entities on daily basis, bi-daily basis, hourly basis) or on a ITT basis (e.g., switching after each ITT, or after every 500 ITTs). In these embodiments, the ITTs are sent to the executing and reporting entity as well as to the responding users, and the liability order messages are sent to the executing and reporting entity (and optionally the originating user), with confirmations sent to the originating and responding users upon execution of the trade. If the order messages are forwarded to the originating user, modification of ITTs due to emerging liquidity in the external market place could be handled in the same manner described above, except that notification of the modification would be sent to the executing and reporting entity as well as the responding users.

In another embodiment of the present invention, ITTs are not sent to any responding users. Instead, each user sends its ITTs to a central server which provides order matching, trade execution, and trade reporting functionality. In this embodiment, when an ITT is received at the central server from a first user, the central server looks for an overlapping ITT from a second user which the first user has permissioned for user-to-user trading of undisclosed liquidity. If it finds an overlapping ITT, it executes the trade in the overlapping amount, notifies the first and second users that the trade has been executed, and then reports the trade to the appropriate exchange. In certain variants of this embodiment, the functionality of the central server can be split between a messaging system, which provides matching, and a trade execution entity, which provides trade execution and reporting.

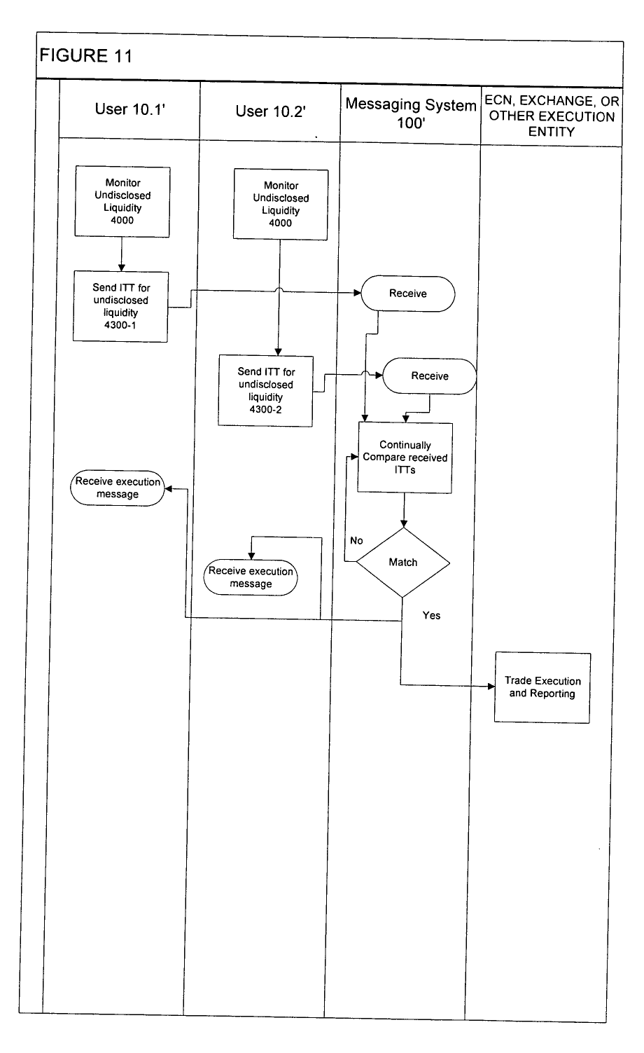

FIG. 11 shows a flow chart detailing such an embodiment. User 10.1′ and user 10.2′ each monitor their respective undisclosed liquidity (step 4000). If the network process for the user (10.1′ or 10.2′) detects an order from that user which includes undisclosed liquidity that should be made available for user-to-user direct trading, it generates an ITT message 401 which is sent to the messaging system 100′ (step 4300-1, 4300-2). Messaging system 100′ receives ITT messages from each of its users (step 4310, 4320), maintains information indicating which users are permissioned to trade with which users, and compares the ITTs for matches between permissioned users (step 4330). Taking as an example the permissioning schedule of FIG. 6, the messaging system would compare ITTs from user 10.1 with ITTs from users 10.2 through 10.5 and compare ITTs from user 10.2 with ITTs from users 10.1 and 10.4. If a match is found (step 4340, yes), the messaging system determines the number of shares (the smaller of the two ITT share quantities) and the price per share (according to a pricing schedule as described above), sends execution messages to each user (steps 4360, 4350), and sends sufficient information to the trade execution entity to execute and report the trade in accordance with the governing securities regulations.

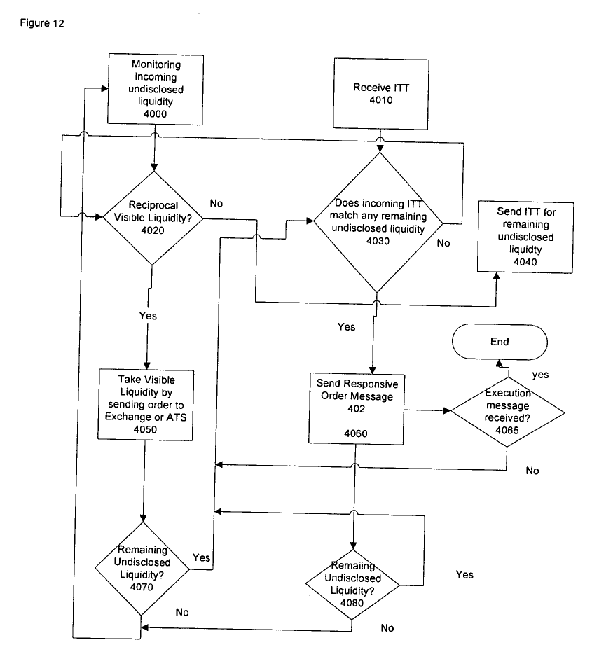

In the flow chart of FIG. 8(a), the process 502 is implemented in a manner which effectively assigns a preference for hitting or taking visible liquidity from exchanges and ATSs, as compared to user-to-user direct trades of undisclosed liquidity, because it hits or takes visible liquidity before it evaluates user to user direct trades of undisclosed liquidity. It should be appreciated, however, that this need not be the case. For example, the process could similarly be configured to assign a preference to user-to-user direct trades by simply reversing the order of steps 4020 and 4030, as illustrated in FIG. 12. Referring to FIG. 12, let us assume a Broker A enters a Buy Sweep for 50000 shares of DELL that is two cents through the offer for a limit price of 29.64. The process first checks the incoming ITTs (step 4030), and sees no matching undisclosed liquidity (Step 4030, no). The process then continues to step 4020, and transmits orders into the market (Step 4050) for all visible quotes totaling, for example, 6,000 shares. Thereafter, Broker B sends an ITT to Broker A to Sell 30000 shares of DELL that is to hit the bid of 29.61. Since there are still 44,000 shares available (step 4070), the process returns to step 4030 and matches the ITT with the remaining undisclosed liquidity (step 4030). The process then transmits an order to Broker B to buy 30,000 shares of DELL. In response, Broker B returns an Execution message to Broker A (step 4070).

In other embodiments, a central server can be used to simply solicit orders from each permissioned user on the behalf of the other. In such an embodiment, the message flow could, for example, include the ITT message, order message, and execution message sequence described in FIG. 5, for example.

An exemplary implementation of the embodiment of FIGS. 5-8 using the architecture and order types of the system of FIGS. 1 and 2 will now be described in more detail.

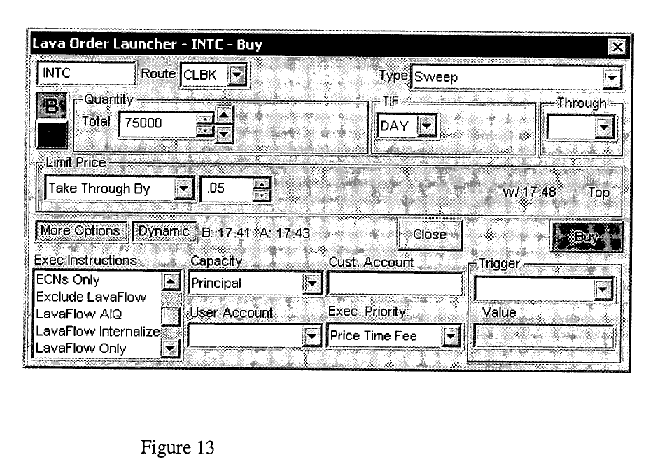

On each user 10′, the network process 502 interprets instructions (e.g., ticket orders) that are received from the user 10′. As described above, these instructions may include limit orders, market orders, sweep orders, probe orders, pegged orders, colorbook market orders, colorbook discretion orders, colorbook probe orders, reserve quantity orders, among others. Preferably, the network process 502 is configured such that the user 10′ can select, on an instruction by instruction basis, whether user-to-user direct trades are enabled. In certain embodiments, the user can specify whether user-to-user direct trades are enabled at the time the order is entered. For example, via a selection in the execution instructions field of FIG. 2, a number of options could be provided. FIG. 13 illustrates several such options. For example, a user-to-user-only execution instruction (referred to as “Lavaflow™ only” in FIG. 13) could indicate that the order should only be executed by a user-to-user direct trade. A “no-user-to-user” execution instruction (referred to as “Exclude Lavaflow™” in FIG. 13) could indicate that the order is not to be sent as a user-to-user direct trade. A “no-same-user” execution instruction (referred to as LavaFlow™ AIQ in FIG. 13) can be used to indicate that the order should not trade against orders from the same broker/dealer if a user-to-user direct trade is executed. An “internal” execution instruction (referred to as LavaFlow™ Internalize in FIG. 13) can be used to indicate that the order should only trade against orders from the same broker/dealer if a user-to-user direct trade is executed. A user-to-user-preferred execution instruction could indicate that the order is to be filled first via any available user-to-user trade and, if this is unsuccessful, then the order can be sent to an ECN or Exchange

In addition to the above, FIG. 13 also illustrates a “Cust. Account” field, an “Exec. Priority” drop down box, a “Trigger” drop down box, and a “Value” field. The “Cust. Account” field is a free-text field in which the user can type in a reference value to associate with the order being entered. The “Exec. Priority” field is used for orders that will be generated to the NASDAQ SuperMontage® execution system. This system supports a number of execution priorities. If none are selected, a customer default will be used. The user can choose one of the supported priorities for using this dropdown box. The “Trigger” drop down box is an optional field which allows a user to specify a triggering condition that must be met before the order will begin to execute. The “Trigger” drop down box indicates which trigger is being chosen, and the “Value” field provides the value associated with the trigger to define the triggering condition.

The following example shows the interaction between two users 10′: broker dealer 10.1′ and broker dealer 10.2′. For the purposes of this example assume that the market is 29.61 by 29.62.

1. Broker Dealer 10.1′ enters an instruction (e.g. ticket order) indicating that it wishes to buy 50,000 shares at a price no more than two cents through the offer for a limit price of 29.64

2. Broker Dealer 10.1's network process checks all liquidity sources (including ITTs from other users 10′ and market data) to discover available liquidity within the limit price on the instruction.

3. Broker Dealer 10.1's network process transmits orders into the market (e.g., exchanges, ECNs) for all visible quotes totaling 6,000 shares.

4. The remaining quantity of 44,000 shares is sent to other permissioned users 10′ as an ITT message via messaging system 100′ at Broker Dealer 10.1's limit price of 29.64.

5. Broker Dealer 10.2′ (a permissioned user) enters a Sell 30,000 Sweep order that is to hit the bid of 29.61

6. Broker Dealer 10.2's network process checks all liquidity sources and received ITTs and sees the Broker Dealer 1O. 1's buy ITT at 29.64

7. Broker Dealer 10.2's network process directs an order via messaging system 100′ to Broker Dealer 10.1′ to sell 30,000 shares at 29.61, which is the limit price that Broker Dealer 10.2′ was prepared to pay.

8. Broker Dealer 10.1's network process receives the incoming order and buys 30,000 shares from Broker Dealer 10.2′ at a price of 29.615, which is the market mid point at the time.

9. Broker Dealer 10.1′ will return an Execution response to Broker Dealer 10.2′ via messaging system 100′

10. Broker Dealer 10.1′ and Broker Dealer 10.2′ report their respective side of the trade.

It should be noted that the network processes 502 may use different types of instructions to implement different strategies for accessing liquidity.

As an example, for Sweep Orders, a user 10′ may configure its network process 502 to simultaneously transmit orders into the market (e.g., to exchanges or ECNS) to access visible liquidity (e.g., market data), and send an ITT (including the limit price of the Sweep Order) to inform its permissioned users of the interest to buy/sell.

For Probe Orders, a user 10′ may configure its network process to transmit the entire quantity of the Probe Order into the market according to the Probe Order algorithm described above, and simultaneously, transmit an ITT to its permission users for the entire quantity at the current price level at which the probe instruction is working. As the price level and/or remaining quantity changes, the network process will update the ITT with the new price level and/or quantity.

As described above, in a probe order, the entire (unexecuted) quantity of the order is sequentially sent to each trade execution entity (e.g., exchange or ECN) as an immediate or cancel order (IOC order). As such, for the first trade execution entity selected, the entire quantity of the Probe Order will be sent, and for each subsequent trade execution entity, the entire remaining unexecuted quantity will be sent. At each point, the trade execution entity selected will be the trade execution entity providing the best price (the current price level). Thus, when the initial IOC order is sent to the first trade execution entity, the entire quantity will also be sent to the permissioned users as an ITT at the current price level. As the current price level changes, the ITT is updated.

As orders are received from permissioned users, they can be executed against the original order quantity less the quantity that is currently committed to the market (e.g. the quantity that has been sent to exchanges and/or ECNs, and not yet canceled). If the entire remaining quantity is committed to the market, the network process may wait for the outstanding unexecuted orders to complete (i.e., either be executed or canceled), and then fill the orders from permissioned users with any canceled quantities.

For Market Orders, the network process can be configured to simultaneously transmit IOC orders into the market to access visible liquidity, and send an ITT to permissioned users. The ITT will include the current market price that the network process is working. In other words, the limit price of the sell (buy) ITT will be set to the highest bid (lowest offer) of the simultaneously transmitted IOC order into the market. As orders are received from permissioned users, they can be executed against the original instruction quantity less the quantity that is currently committed to access the market. As the inside market changes, the network process will modify the limit price at which new IOC orders are sent to the market and will modify the ITT price that was sent to permissioned users.

For Discretionary Orders, the network process can be configured to send an ITT to permissioned users including a limit price that includes the discretion amount.

It should be noted that although the invention has been described above generally in connection with orders placed by traders or other human users via a user interface, this need not be the case. In the context of the present invention, the term “user” refers to a user of the system, which could be a human user such as a trader, or could be a computer(s) which, for example, automatically places orders without human interaction and without the use of a user interface. As an example, in connection with NASDAQ, market makers frequently update market maker quotes, changing one or more of the bid price, offer price, reserve quantity, and show quantity. These updated market maker quotes are generally placed by computers, without human user interaction. Nevertheless, a market maker quote update, which, for example, changed only the reserve quantity associated with a given market maker bid, would, in accordance with the present invention, be an order (e.g., a bid for DELL with a bid price, a show quantity and the updated reserve quantity) from a user (e.g., a computer associated with the market maker) which provided undisclosed liquidity (the reserve quantity) to the CCS 100. Moreover, although the invention is preferably implemented to trade undisclosed liquidity, it should be appreciated that each of the embodiments described above could alternatively be implemented to trade any financial instrument, regardless of whether the order comprises visible liquidity or undisclosed liquidity.

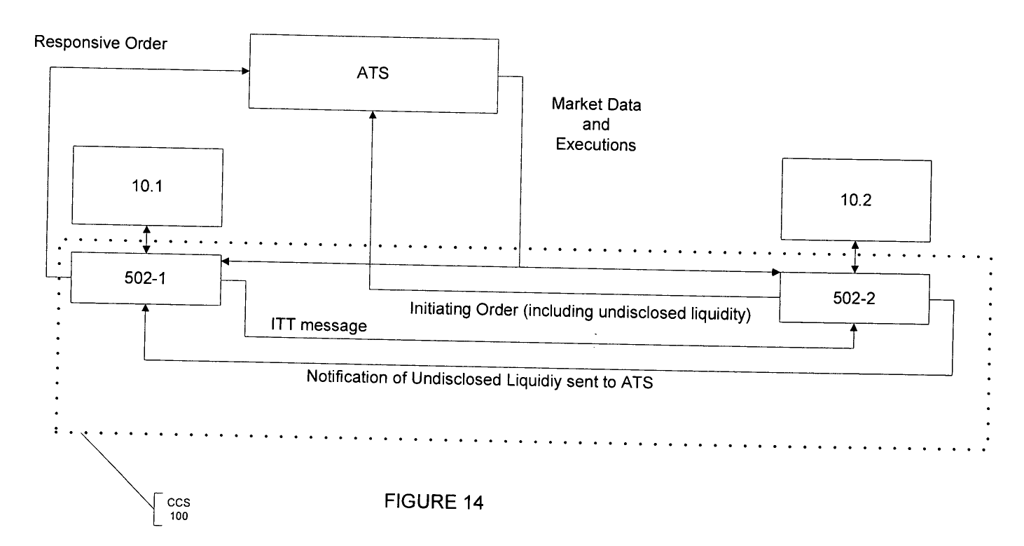

In accordance with another embodiment of the present invention illustrated in FIG. 14, execution based on ITTs occurs at a trade execution entity such as an Exchange, ECN (or other ATS). As described above, by having the user-to-user direct trade execution and reporting performed by a third party such as an ATS, anonymity can be provided to the originating and responding users.

In accordance with a further aspect of this embodiment, intention to trade messages are implemented in the manner described above, and for any intention to trade message, there is an agreed-upon price calculated in accordance with a pricing structure as described above. However, upon receiving an intention to trade message from a first user 10.1, a second user having reciprocal liquidity sends an initiating order at the agreed-upon price to a trade execution entity as undisclosed liquidity, and information regarding the undisclosed liquidity and the trade execution entity is provided to the user who generated the underlying intention to trade message. The initiating order can, for example, be a hidden limit order at the agreed upon price. Alternatively, it could be implemented as a discretionary order with a small displayed quantity. Preferably, the initiating order is sent as an order with a short duration (e.g., 1-2 seconds).

The user who generated the underlying intention to trade message, after receiving the information regarding the undisclosed liquidity and the trade execution entity, sends a responsive order to the trade execution entity. Assuming that the initiating order is still open when the responsive order is received at the trade execution entity, the transaction between the two parties will be completed at the trade execution entity.

In certain embodiments of the present invention, the sharing of information regarding undisclosed liquidity is not limited to initiating orders. Rather, in accordance with these embodiments, CCS 100 utilizes the information it receives and/or maintains regarding the hidden and reserve quantities of its user/traders, and make this information available to reciprocal orders from other of its user/traders. This permits orders to hit or take as large a size as is possible, in essence disregarding the displayed size.

In this regard, an order which is placed through the system 1 may fall into one of three categories: i) orders which add undisclosed liquidity to a trade execution entity, which undisclosed liquidity is known to CCS 100; ii) orders which, via CCS 100, can hit or take the undisclosed liquidity referenced in category (i); and iii) all other orders. In the context of the exemplary LAVA TRADING FLOOR software described above, for example, any reserve quantities “posted” in the “sweep post” order types, the hidden quantity in the sweep post hidden order, the reserve quantity (e.g., total quantity minus show quantity) in pegged orders, native reserve quantity orders, and hidden limit orders would fall under category (i); sweep orders (including the sweep portion of the sweep post orders), or any order which specifies CLBK as the route would fall under category (ii), and non-native reserve quantity orders, and any orders which require a specific route and which do not include a reserve or hidden quantity would fall under category (iii). It should be noted that for an order to fall under category (i), the undisclosed liquidity must actually be sent to the trade execution entity. Thus, non-native reserve quantity orders, in which the undisclosed liquidity remain in CCS 100, are not under category (i).

As an example, let us assume that a user/trader updates a NASDAQ order to Buy 50,000 shares of Dell, displaying 1,000 with 49,000 in reserve. Another user/trader enters a sweep order to sell 60,000 shares at a matching price level. CCS recognizes that in spite of the displayed size of 1000 shares, a total of 50,000 shares are available and hits the bid for 50,000 (which SuperSoes and SuperMontage both allow.)

As another example, let us assume that a user/trader enters an order to INCA (an ECN) to Sell 20,000 shares of Dell at the inside offer price, showing 500 shares, with 19,500 in reserve. A second user/trader enters an order to ISLD (an ESN) to sell 20,000 shares of Dell at 0.05 above the inside offer price. A third user/trader enters a sweep order to Buy 20,000 shares of Dell, with a “Take Through By” 0.10. In a conventional system, the CCS would take 500 shares from INCA, and 19,500 shares from ISLD. However, in accordance with an embodiment of the present invention, CCS recognizes that in spite of the displayed size of 500 shares, a total of 20,000 shares are available and takes the order from INCA for 20,000 (which INCA allows).

As described above, there are a number of other order types which have components that can access multiple trade execution entities. Thus, for example, CCS would follow the same process in the case of the initial sweep of the Sweep Post Hidden, and Sweep and Post order types. Moreover, the CCS would follow the process described above for the “sweep” portion of the “ColorBook Discretion Order-Sweep to Complete” order type, or for any order which specifies CLBK as the route 1020.

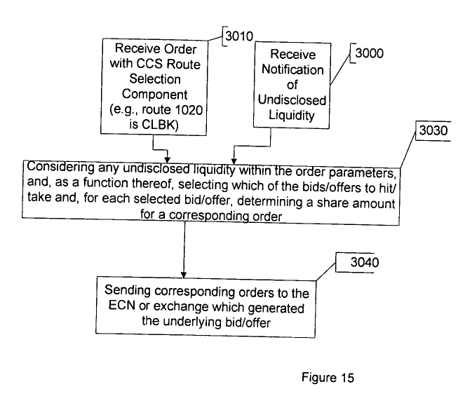

The above-referenced process is described in the flow chart of FIG. 15. CCS 100 receives a notification of undisclosed liquidity in step 3000. For example, CCS 100 may receive a native reserve quantity order, a hidden limit order, a Pegged Order (with a specified show quantity), or a Sweep and Post (e.g., the reserve quantity order posted after the initial sweep). As described above, each of these order types supports the inclusion of undisclosed liquidity.

In step 3010, the CCS 100 receives an order with a CCS Route Selection Component. In this regard, an order with a CCS Route Selection Component is an order which allows CCS 100 to determine the appropriate route (e.g., the appropriate trade execution entity such as an ECN or NASDAQ). In other words, the order does not require that any particular one of the trade execution entities be the recipient of the order. Examples of orders with CCS Route Selection Components include the Sweep Order, Sweep Post Hidden (e.g., the initial sweep portion of this order), Sweep and Post (e.g., the initial sweep portion of this order); ColorBook Market Order, ColorBook Limit Order and the ColorBook Probe Order. In step 3030, CCS 100 processes the order from step 3010.

When processing the order, CCS 100 will consider any undisclosed liquidity received in step 3000 that falls within the order parameters. For example, if the order was a Sell Sweep for 10,000 shares of DELL with a bottom price of 25.80 (field 1200), CCS 100 would consider any undisclosed liquidity for DELL at or above 25.80. Considering this undisclosed liquidity, along with the disclosed liquidity within the order parameters, CCS 100 will select which of the bid/offers to hit/take, and determine a share amount for each of these selected bid/offers. In the sell sweep example described above, CCS 100 would consider bids for DELL at or above 25.80 (including undisclosed liquidity), and fill the order by hitting the highest bid in an amount up to the lesser of 10,000 shares and the available quantity for the highest bid (including any undisclosed liquidity), and then repeating this process for the next highest bid, until either the total amount of selected bids equals 10,000 shares, or until no other bids are available for DELL at or above 25.80. It should be noted that as the system repeats the process for the next highest bid (or lowest offer), the corresponding market data may change, thereby changing the next highest bid (or lowest offer). Preferably, therefore when considering the “next highest bid” (or next lowest offer), the system considers the updated market data (which is undated via the consolidated order book information).

Once the bids/offers and their respective amounts are selected in step 3030, CCS 100 proceeds, in step 3040 to send these selected bids/offers to the trade execution entity (e.g, ECNs, NASDAQ, etc) which generated the underlying bids/offers.

In any event, FIG. 14 illustrates the implementation of ITT transactions through an ATS in connection with the architecture of FIG. 6 (which may or may not implement the functionality of FIG. 15). User 10.1, through process 502-1, sends an intention to trade (ITT) message to its permissioned users, including user 10.2 via process 502-2. As process 502-2 receives orders from user 10.2, it checks its received ITT messages for reciprocal liquidity. If it finds a match, it may send an initiating order including undisclosed liquidity to an ATS such as an ECN. The price of the initiating order is set to match the price which user 10.1 expects in response to its ITT, e.g., the price is set according to the pricing structure associated with the ITT. Process 502-2 also sends information regarding the initiating order to process 502-1, and preferably to all processes 502 in the system, thereby notifying the processes 502 that the undisclosed liquidity has been sent to the ATS. Process 502-1, upon receiving this information, may send a responsive order to the ATS to hit or take the undisclosed liquidity. If the undisclosed liquidity is still available, the ATS will execute the transaction and send execution messages to processes 502-1 and 502-2.

Although this procedure is described in the context of process 502-2 sending information regarding the initiating order to process 502-1, and preferably to all processes 502 in the system, it should be understood that any process or mechanism that allows the information regarding the initiating order to be shared with the other users of the system can be used. For example, a server or process elsewhere in the messaging system 100′ could monitor all undisclosed liquidity which has been sent to any trade execution entity by any of the users 10, and share this information with each process 502 (as described with regard to FIG. 15). Moreover, although the initiating order preferably includes undisclosed liquidity so as not to reveal the buy/sell intentions of the user, it is also possible to implement a system in which the initiating order includes only disclosed liquidity. In such a system, the originator of the ITT would learn of the initiating order through the conventional mechanism of receiving market data.

In any event, the following is a step-by-step example of the interaction between users and the ATS in accordance with the embodiment of FIG. 14:
Assume the current market for DELL is 35.00 bid by 35.10 offer.
User 10.1 enters a Sweep Order to buy 5000 shares of DELL at 35.08.
At process 502-1, the Sweep Order checks the market data and determines that there is no quantity available at the desired price.
Process 502-1 sends an ITT 401 message to all permissioned users of User 10.1 for 5000 shares of DELL at 35.08 (buy).
User 10.2, a permissioned user of User 10.1, enters a Sweep Order to Sell 10,000 shares of DELL at 35.03.
Process 502-2 sees the ITT to Buy 5000 shares of DELL at 35.08.
Process 502-2 determines that it can interact with the ITT at a price of 35.055 (the midpoint of the two limit prices) based upon the pricing structure in effect for the ITT.
Process 502-2 submits a 5000 share hidden limit order to the ECN “INET” to sell DELL at 35.055 with a short duration (the initiating order)
CCS 100, which includes all processes 502, notifies all processes 502 of the hidden limit order sent to INET.
For purposes of this example, assume that User 10.2's hidden limit order to INET does not execute immediately by interacting with existing hidden liquidity on INET.
Process 502-1 sees the undisclosed liquidity on INET to 5000 shares of DELL and 35.055 and determines that this quantity is within the limit price of 35.08.
Process 502-1 sends an Immediate or Cancel (IOC) order to INET (Responding Order) to buy 5000 shares of DELL at 35.055 and cancels its ITT.
Assuming that the Responding Order is the first order received at INET against the Initiating Order, then the Responding Order will execute against the Initiating Order.

In this manner, both users 10.1 and 10.2 have interacted on an external venue (INET) at a midpoint price. Both parties have received a price improvement. Moreover, because the trade occurred at an external venue, full anonymity can be provided to both parties. In addition, since trade execution and reporting are performed by the ATS, the user's are not burdened with performing these functions or complying with any additional regulatory requirements related to these functions. In addition, both parties benefit from the potential for interaction with other hidden or discretionary orders at the ATS, thereby increasing the potential for execution.

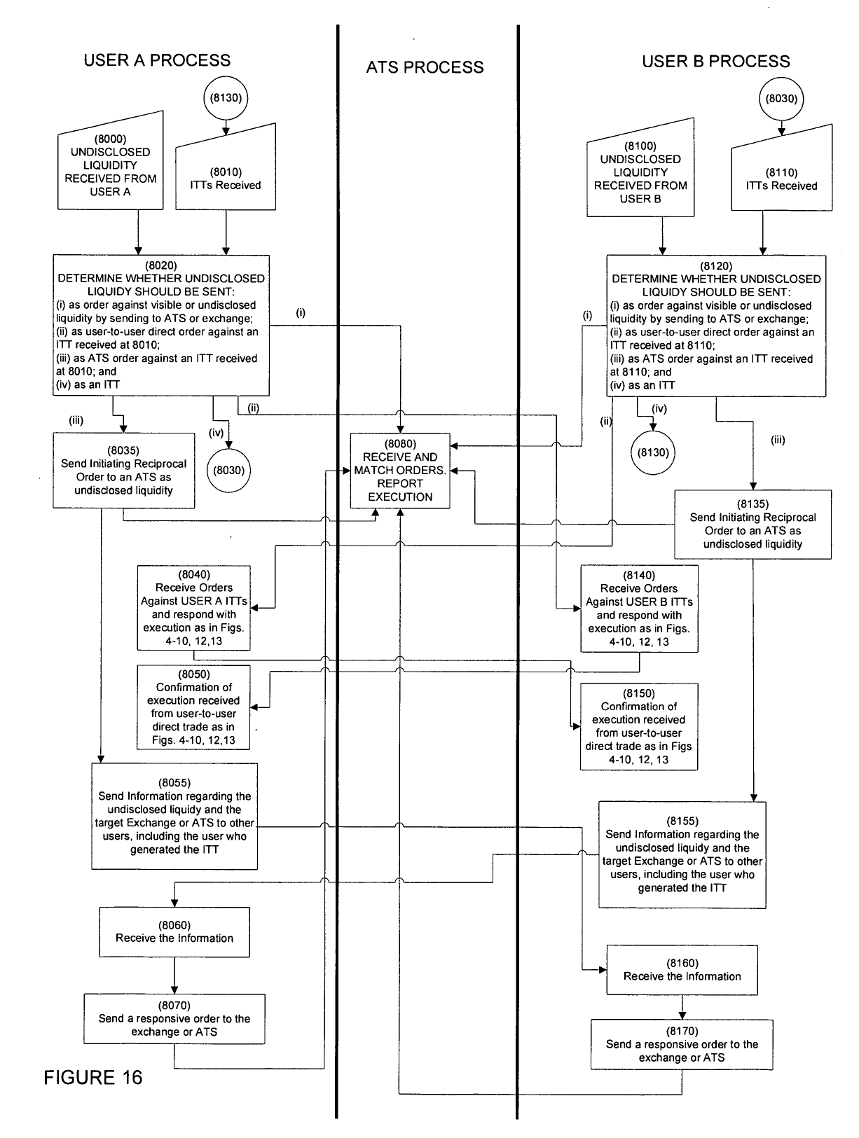

FIG. 16 illustrates the preferred interaction between two users and an ATS in further detail. FIG. 16 is divided into three vertical sections, one labeled “user A process” which includes the process steps performed by one user's process, one labeled “user B process” which includes the process steps performed by another user's process, and one labeled “ATS” which includes the process steps performed by an ATS's process.

User A process receives information regarding undisclosed liquidity received from user A (step 8000) and receives ITTs from its permissioned users (step 8010). Similarly, User B process receives information regarding undisclosed liquidity received from user B (step 8100) and receives ITTs from its permissioned users (step 8110). In this illustration, User A is a permissioned user of User B, and User B is a permissioned user of User A. As such, User A is one of the permissioned users who receives User B's ITTs and User B is one of the permissioned users who receives User A's ITTs.

When undisclosed liquidity is received at step 8100 from User A, the User A Process determines whether the undisclosed liquidity should be sent (i) as order against visible liquidity (e.g., market data) or undisclosed liquidity (e.g., as generated in FIG. 15) by sending an order to an Exchange or ATS; (ii) as a user-to-user direct order against an ITT 401 received at 8110; (iii) as an ATS order against an ITT 401 received at 8110; or (iv) as an ITT 401.

This determination could be made on a wide variety of bases. For example, the user process could first hit or take any reciprocal visible or undisclosed liquidity (option (i)), and then send any remaining undisclosed liquidity as a user-to-user direct order (option (ii)) against a reciprocal ITT, unless the undisclosed liquidity in ineligible for user-to-user direct trades in accordance with system or user policy, in which case the remaining undisclosed liquidity is sent as an ATS/ITT order (option (iii)) against the reciprocal ITT. If no reciprocal ITT is available, then an ITT can be sent out to permissioned users (option (iv)). Alternatively, the system could be configured to first seek user-to-user direct trades (option (i)) or ATS/ITT orders (option (iii)), and then visible or undisclosed liquidity (option (i)). Other schemes can also be implemented.

A number of criteria could be used to determine whether undisclosed liquidity is eligible for user-to-user direct trades. For example, in some implementations, it may not be possible to maintain anonymity through trade execution of user-to-user direct trades. As such, if the user has indicated a desire to maintain anonymity (e.g., wherein the user sets the “through” field 1070), undisclosed liquidity would be ineligible for user-to-user direct trades.

The user might also specify in the underlying order which option is to be chosen. For example, the user could indicate in the execution instructions field 1130 that (i) no user-to-user direct trades are available; (ii) that only user-to-user direct trades are permitted; (iii) that ATS/ITT trades are not permitted; (iv) that only ATS/ITT trades are permitted; etc.

Moreover, the user can indicate in the execution instructions field that any ITT generated from the order (option (iv)) is (i) eligible for user-to-user direct trades but not ATS/ITT trades; (ii) eligible for ATS/ITT trades but not user-to-user direct trades; or (iii) eligible for both ATS/ITT trades and user-to-user direct trades.

Returning to FIG. 16, step 8120, steps 8120(i), (ii), and (iv) can be implemented in the same manner as described above in connection with FIGS. 4-13, and 15. As such, step 8120(iv) causes an ITT 401 to be sent to each permissioned user. As User A is a permissioned user of User B, User A receives any ITT 401 sent by User B, as indicated by reference numeral 8130. Similarly, step 8120(i) causes an order to be sent to the ATS to hit or take the visible or undisclosed liquidity (step 8080). Step 8120(ii) causes an order message 402 to be sent in response to the ITT 401 (in this case from user A), which causes User A process to respond with an execution message 403 (step 8040) in the manner described above in connection with FIGS. 4-10, 12, 13.

If User B process determines that an order is to be sent to an ATS against a received ITT 401 message, then step 8120(iii) is executed, and an initiating order is sent to the ATS as undisclosed liquidity (step 8135). Preferably, the initiating order is at price calculated in accordance with the pricing structure that governs the ITT 401. The initiating order can, for example, be a hidden limit order. Alternatively, it could be implemented as a discretionary order with a small displayed quantity. Information regarding the undisclosed liquidity and the target ATS is sent (step 8155) to other users of the system, including the user who generated the ITT 401. The users receiving the information in step 8155 need not be limited to permissioned users of User B. It should also be noted, that step 8155 can be executed before, after, or simultaneously with step 8135.

In any event, upon receiving the information at step 8060, User A will send a responsive order to the ATS (step 8070) in an attempt to hit or take the initiating order and update the ITT 401 so as to reduce the ITT quantity by the quantity of the responsive order (and to cancel the ITT if the reduced quantity would be zero). If the initiating order is still open, the ATS will execute and report the transaction 8080.

With regard to undisclosed liquidity received from User A, the same procedure is performed as described above, except that execution flows through corresponding steps 8020, 8030, 8035, 8055, 8140, 8150, 8160, 8170.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method for routing orders for financial instruments among users, comprising
(a) transmitting an intention to trade message from a first of a plurality of users to at least two other ones of the plurality of users, the intention to trade message corresponding to a first order on the first user for one of a plurality of financial instruments, the first order including a first symbol component identifying the one of the plurality of financial instruments, a first side component identifying the order as one of a buy order or a sell order, a first price per unit component, and a first unit quantity, the intention to trade message including information indicative of the first side, first symbol, first price per unit component, and first unit quantity;
(b) receiving, at one of the at least two other users, a second order for the one of a plurality of financial instruments from the one of the at least two other users, wherein the second order includes a second symbol component identifying the one of the plurality of financial instruments, a second side component identifying the order as one of a buy order or a sell order, a second price per unit component, and a second unit quantity,
(c) if the second order is a reciprocal order of the first order, sending the second order, or a portion thereof, to a trade execution entity as an initiating order, and sending information indicative of the initiating order to the first user wherein at least a portion of the second unit quantity of the initiating order is an undisclosed quantity, the initiating order having a third price per unit component; and
(d) at the first user, based upon said information indicative of the initiating order sent to the first user, sending a responsive order to the trade execution entity, the responsive order having the first side component, the first symbol component, a unit quantity, and the third price per unit component.

2. The method of claim 1, wherein the trade execution entity is one of a plurality of trade execution entities.

3. The method of claim 1, wherein the unit quantity is less than or equal to the at least
a portion of the second unit quantity of the initiating order.

4. The method of claim 1, wherein each of the plurality of users include a user interface component and a network component, each user interface component interacting with a corresponding end user, each network component providing an interface between its corresponding user interface component and each other network component, wherein steps (a) through (d) are performed at the network components.

5. The method of claim 4, wherein said information is not disclosed to the end user of the first user.

6. The method of claim 1, wherein the third price per unit component is a function of at least one of the first and second price per unit components.

7. The method of claim 1, wherein the third price per unit component is between the first and second price per unit components.

8. The method of claim 1, wherein the third price per unit component is at a midpoint between the first and second price per unit components.

9. The method of claim 1, wherein the third price per unit component is one of the first and second price per unit components.

10. The method of claim 1, wherein the third price per unit component is between an inside bid price and an inside ask price for the one of the plurality of financial instruments.

11. The method of claim 1, wherein the third price per unit component is a function of the first price per unit component, the second price per unit component, an inside bid price for the one of the plurality of financial instruments and an inside ask price for the one of the plurality of financial instruments.

12. The method according to claim 11, wherein one of the first and second orders is a buy order, and the other one of the first and second orders is a sell order, and
1) if the price per unit component of the buy order is less than or equal to the inside bid price, the third price per unit component is the price per unit component of the buy order;
2) if the price per unit component of the sell order is greater than or equal to the inside offer price, the third price per unit component is the price per unit component of the sell order;
3) otherwise, the third price per unit component equals: ((a lower of the price per unit component of the buy order and the inside offer price) plus (a higher of the price per unit component of the sell order and the inside bid price)) divided by 2.

13. A method for routing orders for financial instruments among permissioned users, comprising
(a) receiving an intention to trade message from a first one of one or more permissioned users of a first user, the intention to trade message corresponding to a second order on the first permissioned user for one of a plurality of financial instruments, the second order including a second symbol component identifying the one of the plurality of financial instruments, a second side component identifying the order as one of a buy order or a sell order, a second price per unit component, and a second unit quantity, the intention to trade message including information indicative of the second side, second symbol, second price per unit component, and second unit quantity;
(b) receiving a first order for the one of a plurality of financial instruments from the first user, wherein the first order includes undisclosed liquidity, the first order including a first symbol component identifying the one of the plurality of financial instruments, a first side component identifying the order as one of a buy order or a sell order, a first price per unit component, and a first unit quantity;
(c) if the second order is a reciprocal order of the first order, sending the first order, or a portion thereof, to a trade execution entity as an initiating order, and sending information indicative of the initiating order to the first permissioned user, wherein at least a portion of the second unit quantity of the initiating order is an undisclosed quantity, the initiating order having a third price per unit component;
(d) if the second order is not a reciprocal order of the first order, sending an intention to trade message to each permissioned user, the intention to trade message including information indicative of the first side, first symbol, first price per unit component, and first unit quantity.

14. The method of claim 13, wherein the trade execution entity is one of a plurality of trade execution entities.

15. The method of claim 13, wherein the first user and each of the permissioned users include a user interface component and a network component, each user interface component interacting with a corresponding end user, each network component providing an interface between its corresponding user interface component and each other network component, wherein steps (a) through (d) are performed at the network component of the first user.

16. The method of claim 15, wherein said information is not disclosed to the end user of the first user.

17. The method of claim 13, wherein the third price per unit component is a function of at least one of the first and second price per unit components.

18. The method of claim 13, wherein the third price per unit component is between the first and second price per unit components.

19. The method of claim 13, wherein the third price per unit component is at a midpoint between the first and second price per unit components.

20. The method of claim 13, wherein the third price per unit component is one of the first and second price per unit components.

21. The method of claim 13, wherein the third price per unit component is between an inside bid price and an inside ask price for the one of the plurality of financial instruments.

22. The method of claim 13, wherein the third price per unit component is a function of the first price per unit component, the second price per unit component, an inside bid price for the one of the plurality of financial instruments and an inside ask price for the one of the plurality of financial instruments.

23. The method according to claim 22, wherein one of the first and second orders is a buy order, and the other one of the first and second orders is a sell order, and
1) if the price per unit component of the buy order is less than or equal to the inside bid price, the third price per unit component is the price per unit component of the buy order;
2) if the price per unit component of the sell order is greater than or equal to the inside offer price, the third price per unit component is the price per unit component of the sell order;
3) otherwise, the third price per unit component equals: ((a lower of the price per unit component of the buy order and the inside offer price) plus (a higher of the price per unit component of the sell order and the inside bid price)) divided by 2.

24. A method for routing orders for financial instruments among users, comprising
(a) receiving a first order for one of a plurality of financial instruments from a first user, wherein the first order includes undisclosed liquidity, the first order including a first symbol component identifying the one of the plurality of financial instruments, a first side component identifying the order as one of a buy order or a sell order, a first price per unit component, and a first unit quantity;
(b) sending an intention to trade message to each of a plurality of users, the intention to trade message including information indicative of the first side, first symbol, first price per unit component, and first unit quantity;
(c) receiving information regarding one or more orders containing undisclosed liquidity which have been sent to a trade execution entity by one or more of the plurality of users; and
(d) based on said information, sending a responsive order to the trade execution entity to hit or take the undisclosed liquidity.

25. The method of claim 24, wherein at least one of the one or more orders of step (c) were sent to the trade execution entity in response to the intention to trade message.

26. The method of claim 24, wherein the trade execution entity is one of a plurality of trade execution entities.

27. The method of claim 24, wherein each of the plurality of users include a user interface component and a network component, each user interface component interacting with a corresponding end user, each network component providing an interface between its corresponding user interface component and each other network component, wherein steps (a) through (d) are performed at the network component of the first user.

28. The method of claim 27, wherein said information is not disclosed to the end user of the first user.

29. A method for routing orders for financial instruments among users, comprising
(a) transmitting an intention to trade message from a first of a plurality of users to each other ones of the plurality of users, the intention to trade message corresponding to a first order on the first user for one of a plurality of financial instruments, the first order including a first symbol component identifying the one of the plurality of financial instruments, a first side component identifying the order as one of a buy order or a sell order, a first price per unit component, and a first unit quantity, the intention to trade message including information indicative of the first side, first symbol, first price per unit component, and first unit quantity;
(b) receiving, at each of said other users, a second order for the one of a plurality of financial instruments from the first user, wherein the second order includes a second symbol component identifying the one of the plurality of financial instruments, a second side component identifying the order as one of a buy order or a sell order, a second price per unit component, and a second unit quantity,
(c) at each of said other users, if the second order is a reciprocal order of the first order, sending the second order, or a portion thereof, to a trade execution entity as an initiating order, wherein at least a portion of the second unit quantity of the initiating order is an undisclosed quantity, the initiating order having a third price per unit component;
(d) sending information indicative of the initiating order to the first user;
(e) at the first user, based upon said information indicative of each initiating order sent to the first user, sending a responsive order to the trade execution entity, the responsive order having the first side component, the first symbol component, a unit quantity, and the third price per unit component.

30. The method of claim 29, wherein the trade execution entity is one of a plurality of trade execution entities.

31. The method of claim 29, wherein the unit quantity is less than or equal to the at least a portion of the second unit quantity of the initiating order.

32. The method of claim 29, wherein each of the plurality of users include a user interface component and a network component, each user interface component interacting with a corresponding end user, each network component providing an interface between its corresponding user interface component and each other network component, wherein steps (a) through (e) are performed at the network components.

33. The method of claim 32, wherein said information is not disclosed to the end user of the first user.

34. The method of claim 29, wherein the third price per unit component is a function of at least one of the first and second price per unit components.

35. The method of claim 29, wherein the third price per unit component is between the first and second price per unit components.

36. The method of claim 29, wherein the third price per unit component is at a midpoint between the first and second price per unit components.

37. The method of claim 29, wherein the third price per unit component is one of the first and second price per unit components

38. The method of claim 29, wherein the third price per unit component is between an inside bid price and an inside ask price for the one of the plurality of financial instruments.

39. The method of claim 29, wherein the third price per unit component is a function of the first price per unit component, the second price per unit component, an inside bid price for the one of the plurality of financial instruments and an inside ask price for the one of the plurality of financial instruments.

40. The method according to claim 39, wherein one of the first and second orders is a buy order, and the other one of the first and second orders is a sell order, and
1) if the price per unit component of the buy order is less than or equal to the inside bid price, the third price per unit component is the price per unit component of the buy order;
2) if the price per unit component of the sell order is greater than or equal to the inside offer price, the third price per unit component is the price per unit component of the sell order;
3) otherwise, the third price per unit component equals: ((a lower of the price per unit component of the buy order and the inside offer price) plus (a higher of the price per unit component of the sell order and the inside bid price)) divided by 2.

41. A method for routing orders for financial instruments among users, comprising:
(a) providing a plurality of users, wherein each user designates one or more other users as its permissioned users;
(b) each user selectively generating an intention to trade message, the intention to trade message corresponding to a first order of the user for one of a plurality of financial instruments and sending the intention to trade message to said each user's Permissioned users, the first order including a first symbol component identifying the one of the plurality of financial instruments, a first side component identifying the order as one of a buy order or a sell order, a first price per unit component, and a first unit quantity, the intention to trade message including information indicative of the first side, first symbol, first price per unit component, and first unit quantity;
(c) each user receiving intention to trade messages from its permissioned users; and, selectively sending an initiating order to a trade execution entity, the initiating order corresponding to a reciprocal order for the one of the plurality of financial instruments, the initiating order including a second symbol component identifying the one of the plurality of financial instruments, a second side component identifying the order as one of a buy order or a sell order, a second price per unit component, and a second unit quantity, the second unit quantity including an undisclosed liquidity quantity;
(d) sending information indicative of the initiating order to each of the plurality of users
(e) each user, upon receiving the information from step (d), selectively sending a responsive order to the trade execution entity to hit or take at least a portion of the undisclosed liquidity quantity.

42. The method of claim 41, wherein the trade execution entity is one of a plurality of trade execution entities.

43. The method of claim 41, wherein each of the plurality of users include a user interface component and a network component, each user interface component interacting with a corresponding end user, each network component providing an interface between its corresponding user interface component and each other network component, wherein steps (a) through (e) are performed at the network components.

44. The method of claim 43, wherein said information is not disclosed to the end users of the users receiving the information.

45. A method for routing orders for financial instruments among users, comprising
(a) transmitting an intention to trade message from a first of a plurality of users to at least two other ones of the plurality of users, the intention to trade message corresponding to a first order on the first user for one of a plurality of financial instruments, the first order including a first symbol component identifying the one of the plurality of financial instruments, a first side component identifying the order as one of a buy order or a sell order, a first price per unit component, and a first unit quantity, the intention to trade message including information indicative of the first side, first symbol, first price per unit component, and first unit quantity;
(b) receiving, at one of the at least two other users, a second order for the one of a plurality of financial instruments from the one of the at least two other users, wherein the second order includes a second symbol component identifying the one of the plurality of financial instruments, a second side component identifying the order as one of a buy order or a sell order, a second price per unit component, and a second unit quantity,
(c) if the second order is a reciprocal order of the first order, sending the second order, or a portion thereof, to a trade execution entity as an initiating order, the initiating order having a third price per unit component; and
(d) at the first user, sending a responsive order to the trade execution entity, the responsive order having the first side component, the first symbol component, a unit quantity, and the third price per unit component.

46. A method for routing orders for financial instruments among permissioned users, comprising
(a) receiving an intention to trade message from a first one of one or more permissioned users of a first user, the intention to trade message corresponding to a second order on the first permissioned user for one of a plurality of financial instruments, the second order including a second symbol component identifying the one of the plurality of financial instruments, a second side component identifying the order as one of a buy order or a sell order, a second price per unit component, and a second unit quantity, the intention to trade message including information indicative of the second side, second symbol, second price per unit component, and second unit quantity;
(b) receiving a first order for the one of a plurality of financial instruments from the first user, wherein the first order includes undisclosed liquidity, the first order including a first symbol component identifying the one of the plurality of financial instruments, a first side component identifying the order as one of a buy order or a sell order, a first price per unit component, and a first unit quantity;
(c) if the second order is a reciprocal order of the first order, sending the first order, or a portion thereof, to a trade execution entity as an initiating order, the initiating order having a third price per unit component;
(d) if the second order is not a reciprocal order of the first order, sending an intention to trade message to each permissioned user, the intention to trade message including information indicative of the first side, first symbol, first price per unit component, and first unit quantity.

47. A method for routing orders for financial instruments among users, comprising
(a) transmitting an intention to trade message from a first of a plurality of users to each other ones of the plurality of users, the intention to trade message corresponding to a first order on the first user for one of a plurality of financial instruments, the first order including a first symbol component identifying the one of the plurality of financial instruments, a first side component identifying the order as one of a buy order or a sell order, a first price per unit component, and a first unit quantity, the intention to trade message including information indicative of the first side, first symbol, first price per unit component, and first unit quantity;
(b) receiving, at each of said other users, a second order for the one of a plurality of financial instruments from the first user, wherein the second order includes a second symbol component identifying the one of the plurality of financial instruments, a second side component identifying the order as one of a buy order or a sell order, a second price per unit component, and a second unit quantity, (c) at each of said other users, if the second order is a reciprocal order of the first order, sending the second order, or a portion thereof, to a trade execution entity as an initiating order, the initiating order having a third price per unit component;
(d) at the first user, sending a responsive order to the trade execution entity, the responsive order having the first side component, the first symbol component, a unit quantity, and the third price per unit component.

48. A method for routing orders for financial instruments among users, comprising
(a) transmitting an intention to trade message from a first of a plurality of users to a second of the plurality of users, the intention to trade message corresponding to a first order on the first user for one of a plurality of financial instruments, the first order including a first symbol component identifying the one of the plurality of financial instruments, a first side component identifying the order as one of a buy order or a sell order, a first price per unit component, and a first unit quantity, the intention to trade message including information indicative of the first side, first symbol, first price per unit component, and first unit quantity;
(b) receiving, at the second user, a second order for the one of a plurality of financial instruments from the second user, wherein the second order includes a second symbol component identifying the one of the plurality of financial instruments, a second side component identifying the order as one of a buy order or a sell order, a second price per unit component, and a second unit quantity,
(c) if the second order is a reciprocal order of the first order, sending the second order, or a portion thereof, to a trade execution entity as an initiating order, and sending information indicative of the initiating order to the first user wherein at least a portion of the second unit quantity of the initiating order is an undisclosed quantity, the initiating order having a third price per unit component; and
(d) at the first user, based upon said information indicative of the initiating order sent to the first user, sending a responsive order to the trade execution entity, the responsive order having the first side component, the first symbol component, a unit quantity, and the third price per unit component.

49. A method for routing orders for financial instruments among users, comprising
(a) transmitting an intention to trade message from a first of a plurality of users to a second of the plurality of users, the intention to trade message corresponding to a first order on the first user for one of a plurality of financial instruments, the first order including a first symbol component identifying the one of the plurality of financial instruments, a first side component identifying the order as one of a buy order or a sell order, a first price per unit component, and a first unit quantity, the intention to trade message including information indicative of the first side, first symbol, first price per unit component, and first unit quantity;
(b) receiving, at the second user, a second order for the one of a plurality of financial instruments from the second user, wherein the second order includes a second symbol component identifying the one of the plurality of financial instruments, a second side component identifying the order as one of a buy order or a sell order, a second price per unit component, and a second unit quantity,
(c) if the second order is a reciprocal order of the first order, sending the second order, or a portion thereof, to a trade execution entity as an initiating order, the initiating order having a third price per unit component; and
(d) at the first user, sending a responsive order to the trade execution entity, the responsive order having the first side component, the first symbol component, a unit quantity, and the third price per unit component.

50. Computer readable media, having stored thereon, computer executable process steps for routing orders for financial instruments among permissioned users, comprising
(a) receiving an intention to trade message from a first one of one or more permissioned users of a first user, the intention to trade message corresponding to a second order on the first permissioned user for one of a plurality of financial instruments, the second order including a second symbol component identifying the one of the plurality of financial instruments, a second side component identifying the order as one of a buy order or a sell order, a second price per unit component, and a second unit quantity, the intention to trade message including information indicative of the second side, second symbol, second price per unit component, and second unit quantity;
(b) receiving a first order for the one of a plurality of financial instruments from the first user, wherein the first order includes undisclosed liquidity, the first order including a first symbol component identifying the one of the plurality of financial instruments, a first side component identifying the order as one of a buy order or a sell order, a first price per unit component, and a first unit quantity;
(c) if the second order is a reciprocal order of the first order, sending the first order, or a portion thereof, to a trade execution entity as an initiating order, and sending information indicative of the initiating order to the first permissioned user, wherein at least a portion of the second unit quantity of the initiating order is an undisclosed quantity, the initiating order having a third price per unit component;
(d) if the second order is not a reciprocal order of the first order, sending an intention to trade message to each permissioned user, the intention to trade message including information indicative of the first side, first symbol, first price per unit component, and first unit quantity.

51. Computer readable media, having stored thereon, computer executable process steps for routing orders for financial instruments among users, comprising
(a) receiving a first order for one of a plurality of financial instruments from a first user, wherein the first order includes undisclosed liquidity, the first order including a first symbol component identifying the one of the plurality of financial instruments, a first side component identifying the order as one of a buy order or a sell order, a first price per unit component, and a first unit quantity;
(b) sending an intention to trade message to each of a plurality of users, the intention to trade message including information indicative of the first side, first symbol, first price per unit component, and first unit quantity;
(c) receiving information regarding one or more orders containing undisclosed liquidity which have been sent to a trade execution entity by one or more of the plurality of users; and
(d) based on said information, sending a responsive order to the trade execution entity to hit or take the undisclosed liquidity.

52. Computer readable media, having stored thereon, computer executable process steps for routing orders for financial instruments among users, comprising
(a) transmitting an intention to trade message from a first of a plurality of users to each other ones of the plurality of users, the intention to trade message corresponding to a first order on the first user for one of a plurality of financial instruments, the first order including a first symbol component identifying the one of the plurality of financial instruments, a first side component identifying the order as one of a buy order or a sell order, a first price per unit component, and a first unit quantity, the intention to trade message including information indicative of the first side, first symbol, first price per unit component, and first unit quantity;
(b) receiving, at each of said other users, a second order for the one of a plurality of financial instruments from the first user, wherein the second order includes a second symbol component identifying the one of the plurality of financial instruments, a second side component identifying the order as one of a buy order or a sell order, a second price per unit component, and a second unit quantity,
(c) at each of said other users, if the second order is a reciprocal order of the first order, sending the second order, or a portion thereof, to a trade execution entity as an initiating order, wherein at least a portion of the second unit quantity of the initiating order is an undisclosed quantity, the initiating order having a third price per unit component;
(d) sending information indicative of the initiating order to the first user;
(e) at the first user, based upon said information indicative of each initiating order sent to the first user, sending a responsive order to the trade execution entity, the responsive order having the first side component, the first symbol component, a unit quantity, and the third price per unit component.

53. Computer readable media, having stored thereon, computer executable process steps for routing orders for financial instruments among permissioned users, comprising
(a) receiving an intention to trade message from a first one of one or more permissioned users of a first user, the intention to trade message corresponding to a second order on the first permissioned user for one of a plurality of financial instruments, the second order including a second symbol component identifying the one of the plurality of financial instruments, a second side component identifying the order as one of a buy order or a sell order, a second price per unit component, and a second unit quantity, the intention to trade message including information indicative of the second side, second symbol, second price per unit component, and second unit quantity;
(b) receiving a first order for the one of a plurality of financial instruments from the first user, wherein the first order includes undisclosed liquidity, the first order including a first symbol component identifying the one of the plurality of financial instruments, a first side component identifying the order as one of a buy order or a sell order, a first price per unit component, and a first unit quantity;
(c) if the second order is a reciprocal order of the first order, sending the first order, or a portion thereof, to a trade execution entity as an initiating order, the initiating order having a third price per unit component;
(d) if the second order is not a reciprocal order of the first order, sending an intention to trade message to each permissioned user, the intention to trade message including information indicative of the first side, first symbol, first price per unit component, and first unit quantity.

54. Computer readable media, having stored thereon, computer executable process steps for routing orders for financial instruments among users, comprising
(a) transmitting an intention to trade message from a first of a plurality of users to each other ones of the plurality of users, the intention to trade message corresponding to a first order on the first user for one of a plurality of financial instruments, the first order including a first symbol component identifying the one of the plurality of financial instruments, a first side component identifying the order as one of a buy order or a sell order, a first price per unit component, and a first unit quantity, the intention to trade message including information indicative of the first side, first symbol, first price per unit component, and first unit quantity;
(b) receiving, at each of said other users, a second order for the one of a plurality of financial instruments from the first user, wherein the second order includes a second symbol component identifying the one of the plurality of financial instruments, a second side component identifying the order as one of a buy order or a sell order, a second price per unit component, and a second unit quantity,
(c) at each of said other users, if the second order is a reciprocal order of the first order, sending the second order, or a portion thereof, to a trade execution entity as an initiating order, the initiating order having a third price per unit component;
(d) at the first user, sending a responsive order to the trade execution entity, the responsive order having the first side component, the first symbol component, a unit quantity, and the third price per unit component.

55. Computer readable media, having stored thereon, computer executable process steps for routing orders for financial instruments among users, comprising
(a) transmitting an intention to trade message from a first of a plurality of users to a second of the plurality of users, the intention to trade message corresponding to a first order on the first user for one of a plurality of financial instruments, the first order including a first symbol component identifying the one of the plurality of financial instruments, a first side component identifying the order as one of a buy order or a sell order, a first price per unit component, and a first unit quantity, the intention to trade message including information indicative of the first side, first symbol, first price per unit component, and first unit quantity;
(b) receiving, at the second user, a second order for the one of a plurality of financial instruments from the second user, wherein the second order includes a second symbol component identifying the one of the plurality of financial instruments, a second side component identifying the order as one of a buy order or a sell order, a second price per unit component, and a second unit quantity,
(c) if the second order is a reciprocal order of the first order, sending the second order, or a portion thereof, to a trade execution entity as an initiating order, and sending information indicative of the initiating order to the first user wherein at least a portion of the second unit quantity of the initiating order is an undisclosed quantity, the initiating order having a third price per unit component; and
(d) at the first user, based upon said information indicative of the initiating order sent to the first user, sending a responsive order to the trade execution entity, the responsive order having the first side component, the first symbol component, a unit quantity, and the third price per unit component.

56. Computer readable media, having stored thereon, computer executable process steps for routing orders for financial instruments among users, comprising
(a) transmitting an intention to trade message from a first of a plurality of users to a second of the plurality of users, the intention to trade message corresponding to a first order on the first user for one of a plurality of financial instruments, the first order including a first symbol component identifying the one of the plurality of financial instruments, a first side component identifying the order as one of a buy order or a sell order, a first price per unit component, and a first unit quantity, the intention to trade message including information indicative of the first side, first symbol, first price per unit component, and first unit quantity;
(b) receiving, at the second user, a second order for the one of a plurality of financial instruments from the second user, wherein the second order includes a second symbol component identifying the one of the plurality of financial instruments, a second side component identifying the order as one of a buy order or a sell order, a second price per unit component, and a second unit quantity,
(c) if the second order is a reciprocal order of the first order, sending the second order, or a portion thereof, to a trade execution entity as an initiating order, the initiating order having a third price per unit component; and
(d) at the first user, sending a responsive order to the trade execution entity, the responsive order having the first side component, the first symbol component, a unit quantity, and the third price per unit component.

57. A system for routing orders for financial instruments among permissioned users, comprising, on one or more computers:
(a) receiving an intention to trade message from a first one of one or more permissioned users of a first user, the intention to trade message corresponding to a second order on the first permissioned user for one of a plurality of financial instruments, the second order including a second symbol component identifying the one of the plurality of financial instruments, a second side component identifying the order as one of a buy order or a sell order, a second price per unit component, and a second unit quantity, the intention to trade message including information indicative of the second side, second symbol, second price per unit component, and second unit quantity;
(b) receiving a first order for the one of a plurality of financial instruments from the first user, wherein the first order includes undisclosed liquidity, the first order including a first symbol component identifying the one of the plurality of financial instruments, a first side component identifying the order as one of a buy order or a sell order, a first price per unit component, and a first unit quantity;
(c) if the second order is a reciprocal order of the first order, sending the first order, or a portion thereof, to a trade execution entity as an initiating order, and sending information indicative of the initiating order to the first permissioned user, wherein at least a portion of the second unit quantity of the initiating order is an undisclosed quantity, the initiating order having a third price per unit component;
(d) if the second order is not a reciprocal order of the first order, sending an intention to trade message to each permissioned user, the intention to trade message including information indicative of the first side, first symbol, first price per unit component, and first unit quantity.

58. A system for routing orders for financial instruments among users, comprising, on one or more computers,
(a) receiving a first order for one of a plurality of financial instruments from a first user, wherein the first order includes undisclosed liquidity, the first order including a first symbol component identifying the one of the plurality of financial instruments, a first side component identifying the order as one of a buy order or a sell order, a first price per unit component, and a first unit quantity;
(b) sending an intention to trade message to each of a plurality of users, the intention to trade message including information indicative of the first side, first symbol, first price per unit component, and first unit quantity;
(c) receiving information regarding one or more orders containing undisclosed liquidity which have been sent to a trade execution entity by one or more of the plurality of users; and
(d) based on said information, sending a responsive order to the trade execution entity to hit or take the undisclosed liquidity.

59. A system for routing orders for financial instruments among users, comprising, on one or more computers
(a) transmitting an intention to trade message from a first of a plurality of users to each other ones of the plurality of users, the intention to trade message corresponding to a first order on the first user for one of a plurality of financial instruments, the first order including a first symbol component identifying the one of the plurality of financial instruments, a first side component identifying the order as one of a buy order or a sell order, a first price per unit component, and a first unit quantity, the intention to trade message including information indicative of the first side, first symbol, first price per unit component, and first unit quantity;
(b) receiving, at each of said other users, a second order for the one of a plurality of financial instruments from the first user, wherein the second order includes a second symbol component identifying the one of the plurality of financial instruments, a second side component identifying the order as one of a buy order or a sell order, a second price per unit component, and a second unit quantity,
(c) at each of said other users, if the second order is a reciprocal order of the first order, sending the second order, or a portion thereof, to a trade execution entity as an initiating order, wherein at least a portion of the second unit quantity of the initiating order is an undisclosed quantity, the initiating order having a third price per unit component;
(d) sending information indicative of the initiating order to the first user;
(e) at the first user, based upon said information indicative of each initiating order sent to the first user, sending a responsive order to the trade execution entity, the responsive order having the first side component, the first symbol component, a unit quantity, and the third price per unit component.

60. The system of claim 59, wherein the one or more computers include a plurality of computers, and wherein each of the plurality of users include a user interface component and a network component on at least one of the plurality of computers, each user interface component interacting with a corresponding end user, each network component providing an interface between its corresponding user interface component and each other network component, wherein steps (a) through (e) are performed at the network components.
